(19) United States
(12) Patent Application Publication
(10) Pub. No.: US 2023/0121647 A1
(43) Pub. Date: Apr. 20, 2023

(54) MACHINE LEARNING-ENABLED SYSTEM FOR ANALYZING IMMIGRATION PETITIONS

(71) Applicant: Software Pundits Pvt. Ltd., Bangalore Karnataka (IN)

(72) Inventors: Durgaprasad N. Rao, Cambridge, MA (US); Aditya Prabhakar, Bangalore Karnataka (IN)

(21) Appl. No.: 17/866,162

(22) Filed: Jul. 15, 2022

(30) Foreign Application Priority Data
Jul. 15, 2021 (IN) 202141031949

(51) Int. Cl. G06Q 50/26

(52) U.S. Cl. CPC G06Q 50/26

(57) ABSTRACT

A machine learning-enabled system for generating and analyzing visa and immigration petitions that includes a neural network-enabled petition analysis module trained on the past beneficiary data and past petition data of past petitions (that have been granted and denied) for determining the likelihood of a visa or immigration petitions being granted. Using the model, the system outputs an indication of the likelihood of a generated petition being granted and provides insight into changes that can be made to increase the likelihood of the generated petition being granted. In some embodiments, the system also includes a drag-and-drop visa workflow designer that enables a user to specify, for type of visa and immigration petition, tasks that need to be performed by each of the petitioner and the beneficiary and information and documents that need to be supplied by each of the petitioner and the beneficiary.

### CROSS-REFERENCE TO RELATED APPLICATIONS

This application claims priority to Indian Provisional Patent Application No. 202141031949, filed Jul. 15, 2021, which is hereby incorporated by reference.

### FEDERAL FUNDING

None

### BACKGROUND

Prior art software applications help immigration attorneys generate visa and immigration petitions by storing data for specific petitions and beneficiaries and inserting that data into visa and immigration forms. However, those software applications do not provide insight into whether those petitions are likely to be granted or include features enabling those attorneys and petitioners increase the likelihood of those petitions being granted.

Additionally, filling out forms is just one part of the petitions process, which requires coordination with petitioners and beneficiaries to gather the information and documents necessary to generate the visa and immigration petitions and, in some instances, respond to requests for evidence. Using convention software, attorneys have to use conventional communications methods like email and phone calls to keep petitioners and beneficiaries informed of the steps they need to take and to gather the required information and documents from those petitioners and beneficiaries.

### SUMMARY

Disclosed is a machine learning-enabled system for generating and analyzing visa and immigration petitions. The system includes a user interface for receiving beneficiary data, petition data, and subject matter paragraphs and a petition building module that generates visa and immigration petitions by inserting the beneficiary data and the petition data into visa and immigration forms and combining the subject matter paragraphs and the beneficiary data and the petition data to generate support letters.

Additionally, the system includes a neural-network enabled petition analysis module that is trained on the past beneficiary data and past petition data of past petitions that have been granted and denied to develop a model for determining the likelihood of a visa or immigration petitions being granted. Using the model, the system outputs an indication of the likelihood of a generated petition being granted and provides insight into changes that can be made to increase the likelihood of that generated petition being granted.

In some embodiments, the system also includes a drag-and-drop visa workflow designer that enables a user to specify, for type of visa and immigration petition, tasks that need to be performed by each of the petitioner and the beneficiary and information and documents that need to be supplied by each of the petitioner and the beneficiary.

In each embodiment, the system includes functionality to generate petitions that are more likely to be granted. For employment-based immigration, for instance, the system stores the occupational duties of occupations considered to be specialty occupations under existing law, provides functionality for users to match the required duties of the position to the occupational duties of the specialty occupation, and generates a support letter with a draft argument that the position qualifies as the specialty occupation because the position includes job duties that match each of the occupational duties of the specialty occupation.

### BRIEF DESCRIPTION OF THE DRAWINGS

Aspects of exemplary embodiments may be better understood with reference to the accompanying drawings. The components in the drawings are not necessarily to scale, emphasis instead being placed upon illustrating the principles of exemplary embodiments.

FIG. 1 is a diagram of an architecture of a machine-learning enabled system for analyzing immigration petitions according to an exemplary embodiment.

FIG. 2 is a block diagram of the machine-learning enabled system for analyzing immigration petitions according to an exemplary embodiment.

FIG. 3 is a block diagram of a Standard Occupational Classification (SOC) code recommendation module and a petition generation module according to an exemplary embodiment.

FIG. 4A is a view of a beneficiary user interface (UI) according to an exemplary embodiment.

FIG. 4B is another view of the beneficiary UI according to an exemplary embodiment.

FIG. 4C is another view of the beneficiary UI according to an exemplary embodiment.

FIG. 4C is another view of the beneficiary UI according to an exemplary embodiment.

FIG. 5A is a view of a petitioner UI or an attorney UI according to an exemplary embodiment.

FIG. 5B is another view of the petitioner UI or the attorney UI according to an exemplary embodiment.

FIG. 5C is another view of the petitioner UI or the attorney UI according to an exemplary embodiment.

FIG. 5D is another view of the petitioner UI or the attorney UI according to an exemplary embodiment.

FIG. 5E is another view of the petitioner UI or the attorney UI according to an exemplary embodiment.

FIG. 5F is another view of the petitioner UI or the attorney UI according to an exemplary embodiment.

FIG. 6 is a block diagram of a petition analysis module according to an exemplary embodiment.

FIG. 7A is a view of a visa workflow designer according to an exemplary embodiment.

FIG. 7B is another view of the visa workflow designer according to an exemplary embodiment.

FIG. 7C is another view of the visa workflow designer according to an exemplary embodiment.

FIG. 7D is another view of the visa workflow designer according to an exemplary embodiment.

FIG. 7E is another view of the visa workflow designer according to an exemplary embodiment.

FIG. 7F is another view of the visa workflow designer according to an exemplary embodiment.

FIG. 7G is another view of the visa workflow designer according to an exemplary embodiment.

FIG. 7H is another view of the visa workflow designer according to an exemplary embodiment.

FIG. 7I is another view of the visa workflow designer according to an exemplary embodiment.

FIG. 7J is another view of the visa workflow designer according to an exemplary embodiment.

FIG. 8A is a view of a Request for Evidence (RFE) response builder according to an exemplary embodiment.

FIG. 8B is another view of the RFE response builder according to an exemplary embodiment.

FIG. 8C is another view of the RFE response builder according to an exemplary embodiment.

FIG. 8D is another view of the RFE response builder according to an exemplary embodiment.

FIG. 8E is another view of the RFE response builder according to an exemplary embodiment.

FIG. 8F is another view of the RFE response builder according to an exemplary embodiment.

FIG. 8G is another view of the RFE response builder according to an exemplary embodiment.

FIG. 8H is another view of the RFE response builder according to an exemplary embodiment.

FIG. 8I is another view of the RFE response builder according to an exemplary embodiment.

FIG. 8J is another view of the RFE response builder according to an exemplary embodiment.

FIG. 8K is another view of the RFE response builder according to an exemplary embodiment.

FIG. 8L is another view of the RFE response builder according to an exemplary embodiment.

FIG. 8M is another view of the RFE response builder according to an exemplary embodiment.

FIG. 9A is a view of a journey-based professional UI according to an exemplary embodiment.

FIG. 9B is another view of the journey-based professional UI according to an exemplary embodiment.

FIG. 9C is another view of the journey-based professional UI according to an exemplary embodiment.

FIG. 9D is another view of the journey-based professional UI according to an exemplary embodiment.

FIG. 10A is a view of a journey-based student UI according to an exemplary embodiment.

FIG. 10B is another view of the journey-based student UI according to an exemplary embodiment.

FIG. 10C is another view of the journey-based student UI according to an exemplary embodiment.

FIG. 11A is a view of a visa stamping UI according to an exemplary embodiment.

FIG. 11B is another view of the visa stamping UI according to an exemplary embodiment.

FIG. 11C is another view of the visa stamping UI according to an exemplary embodiment.

### DETAILED DESCRIPTION

Reference to the drawings illustrating various views of exemplary embodiments is now made. In the drawings and the description of the drawings herein, certain terminology is used for convenience only and is not to be taken as limiting the embodiments of the present invention. Furthermore, in the drawings and the description below, like numerals indicate like elements throughout.

### System Architecture

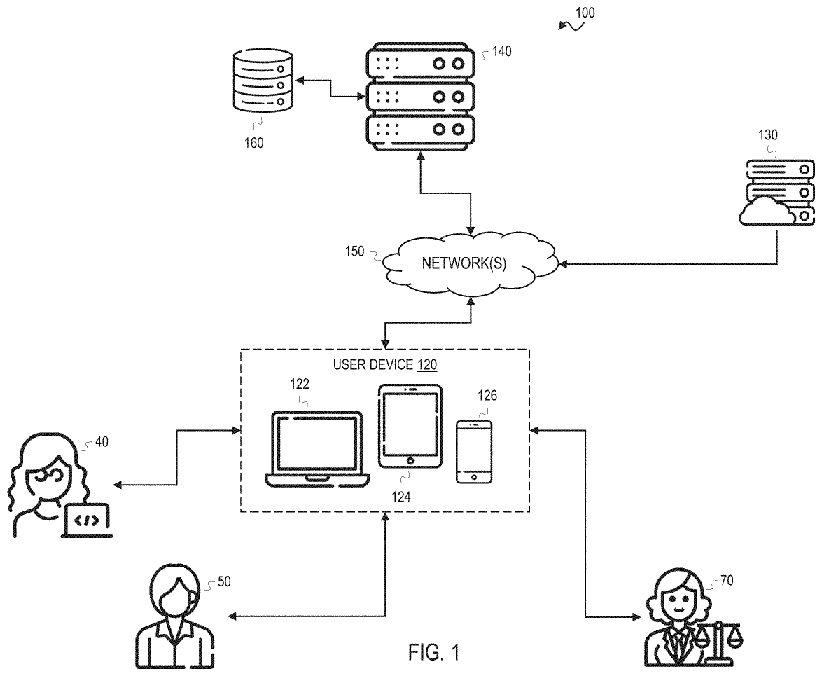

FIG. 1 is a diagram of an architecture 100 of a machine-learning enabled system 200 for analyzing immigration petitions according to an exemplary embodiment.

As shown in FIG. 1, the architecture 100 includes a server 140 in communication with user devices 120 via one or more computer networks 150. The server 140 stores data in non-transitory computer readable storage media 160 and may also receive data from third-party computer systems 130 via the computer network(s) 150. As described in detail below, the system 200 provides functionality via the user devices 120 for attorneys 70 and petitioners 50 filing immigration petitions as well as the beneficiaries 40 of those immigration petitions.

The server 140 may be any hardware computing device that stores instructions includes one or more hardware computer processing units that execute those instructions to perform the functions described herein. The user devices 120 may include any hardware computing device having one or more hardware computer processors that perform the functions described herein. For example, the user devices 120 may include personal computers 122 (desktop computers, notebook computers, etc.), tablet computers 124, smartphones 126, etc.

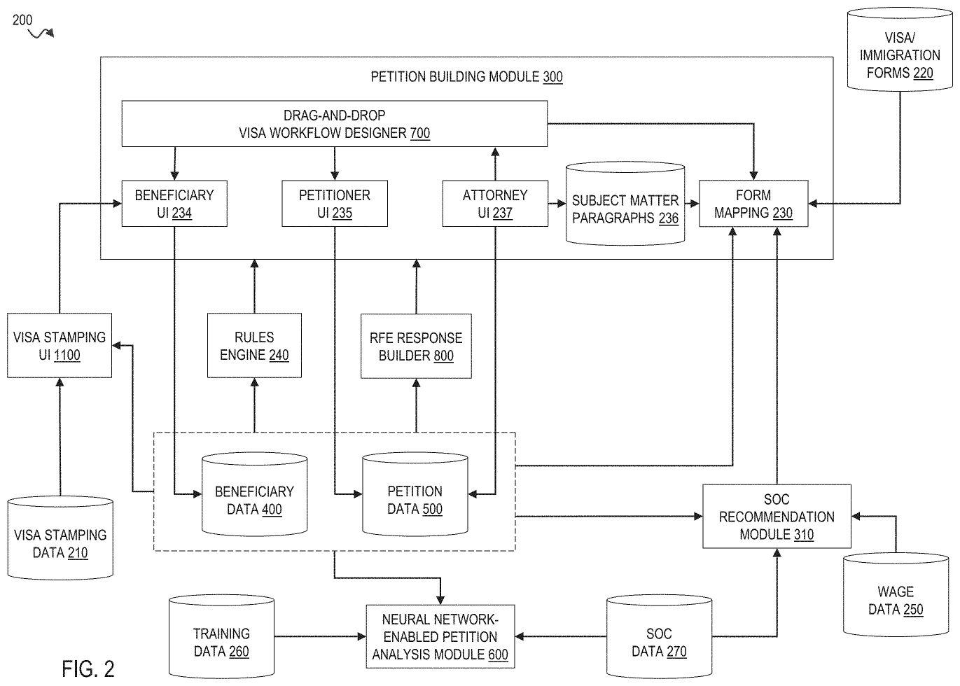

FIG. 2 is a block diagram of the machine-learning enabled system 200 for analyzing immigration petitions according to an exemplary embodiment.

As shown in FIG. 2, the system 200 includes a petition generation module 300 for receiving beneficiary data 400 and petition data 500 and generating a petition as well as a neural network-enabled petition analysis module 600 for analyzing that beneficiary data 400 and petition data 500 and determining the likelihood that the generated petition 390 will be granted or denied. In the embodiment of FIG. 2, the system 200 also includes a standard occupational classification (SOC) code recommendation module 310, a rules engine 240, a Request for Evidence (RFE) response builder 800, and a visa stamping user interface (UI) 1100.

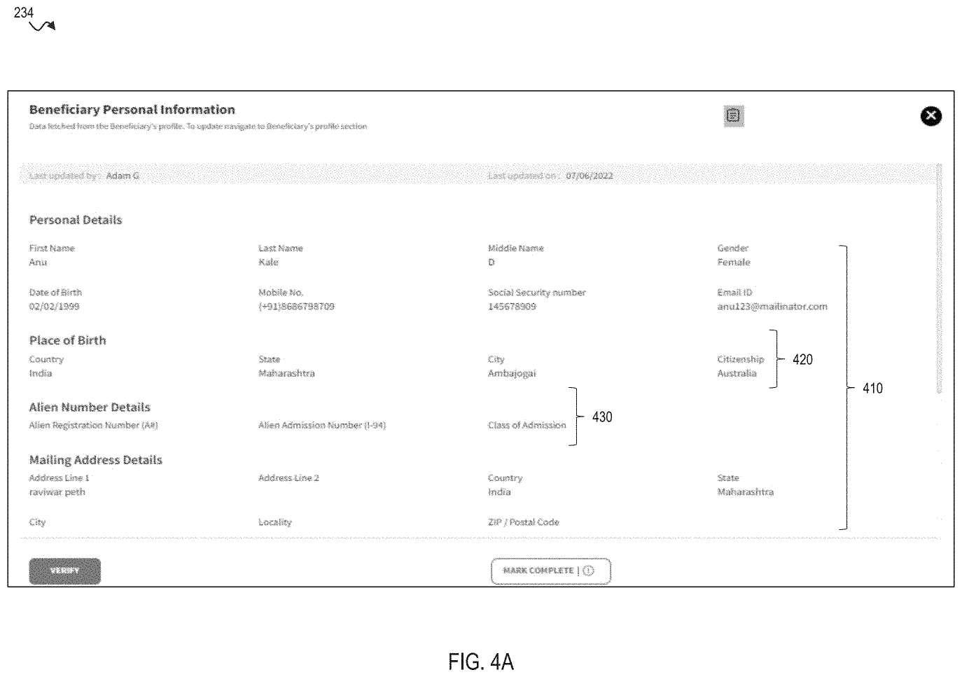

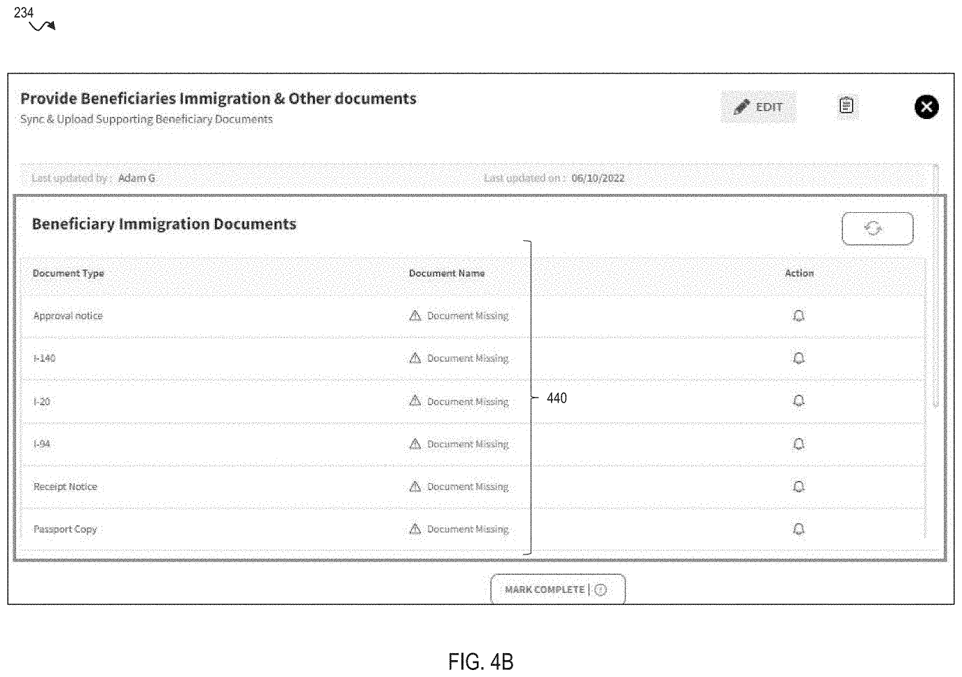

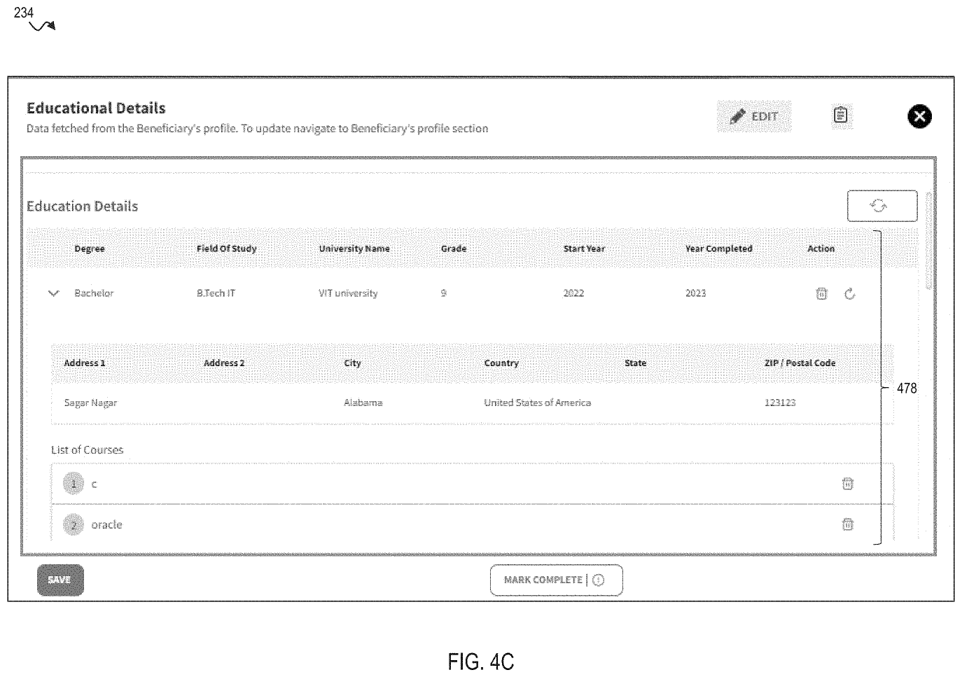

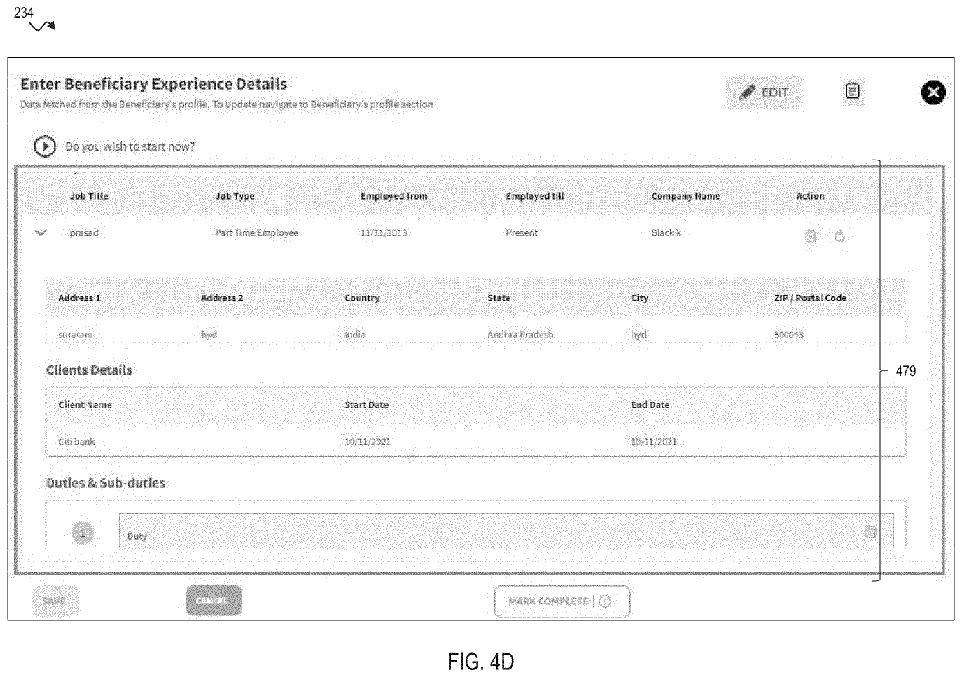

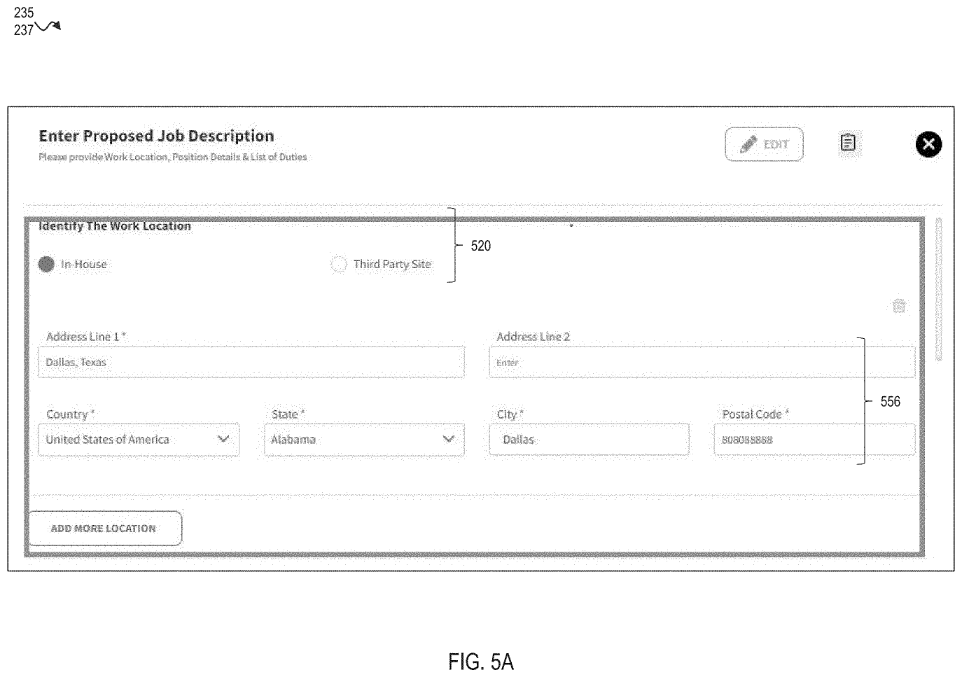

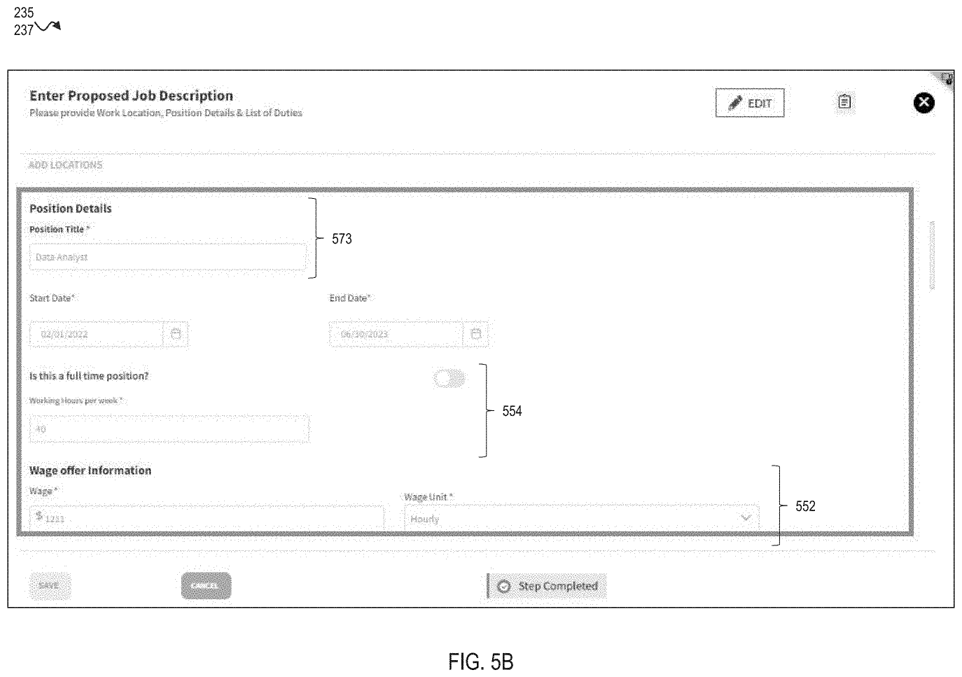

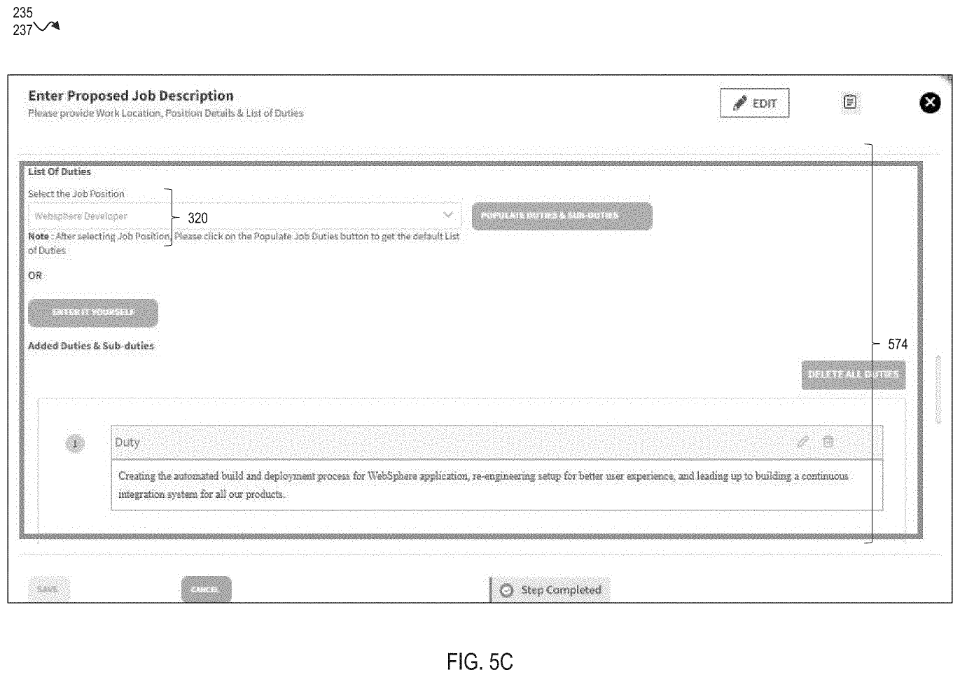

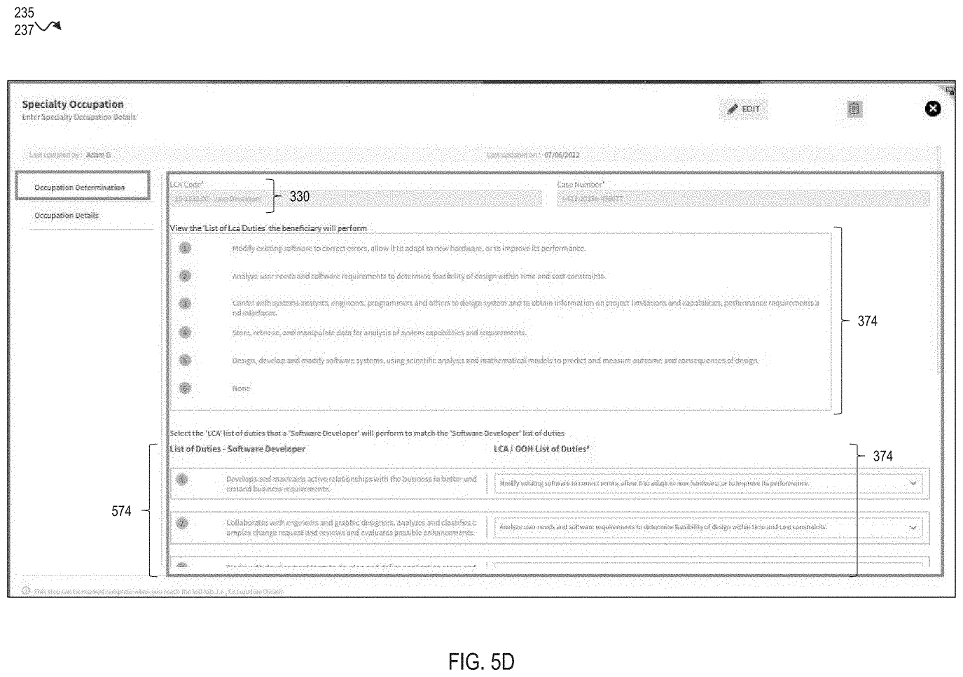

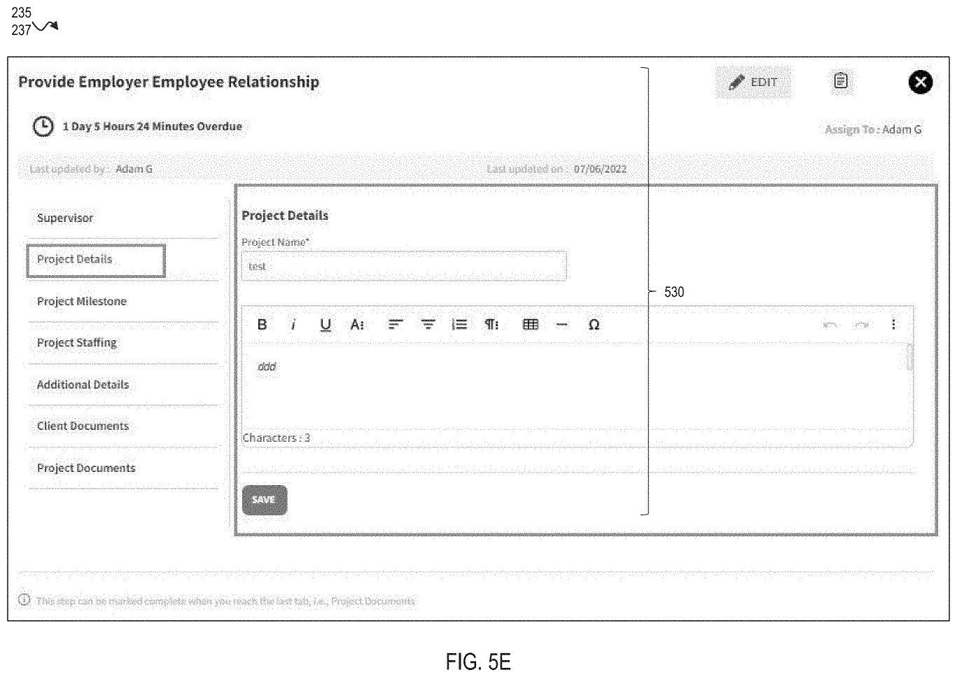

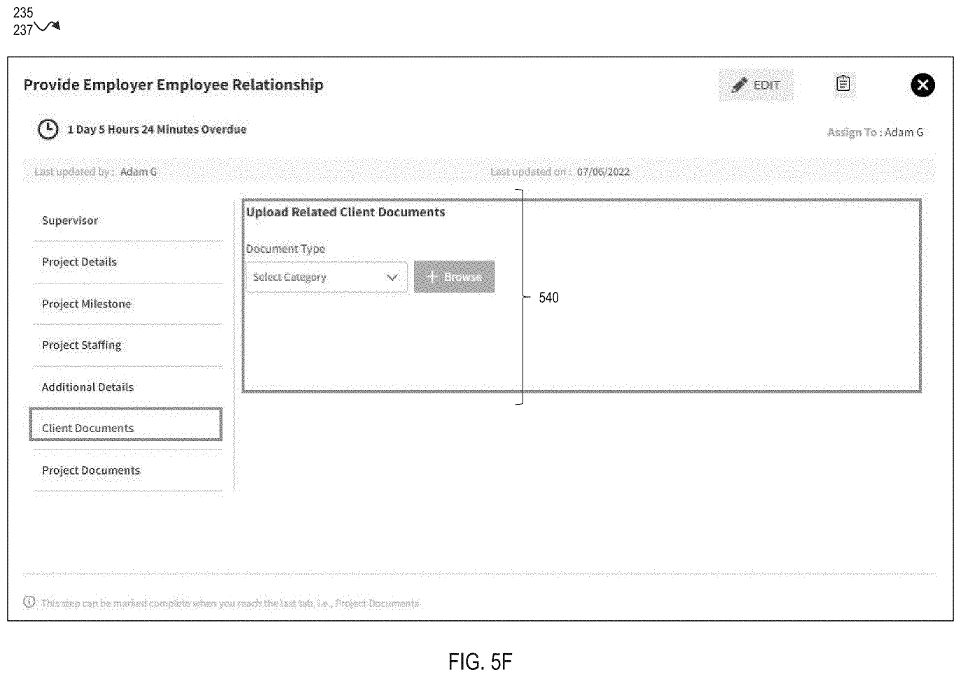

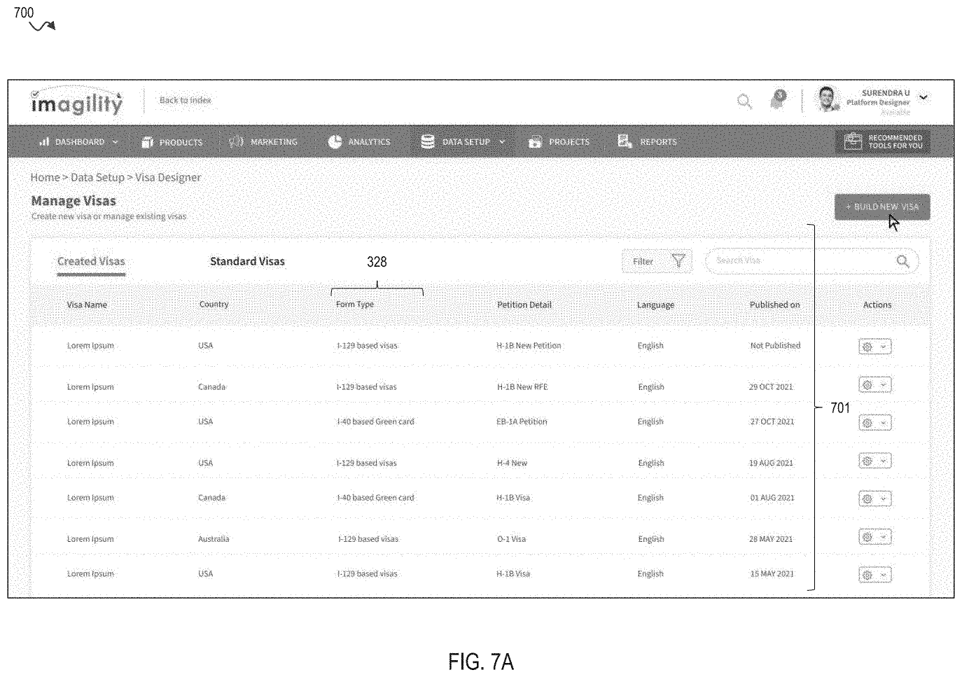

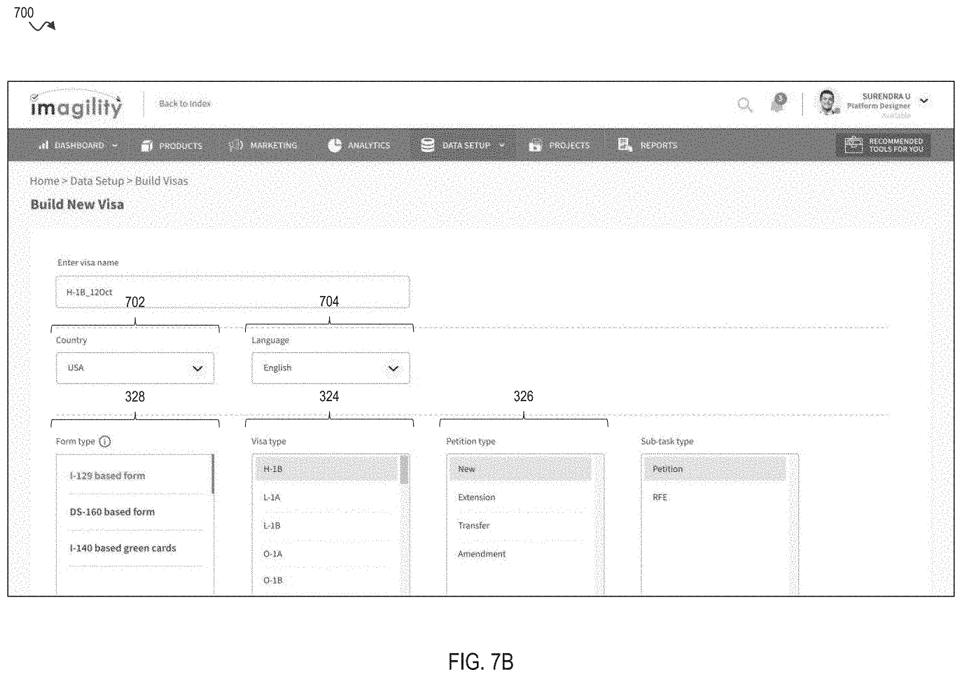

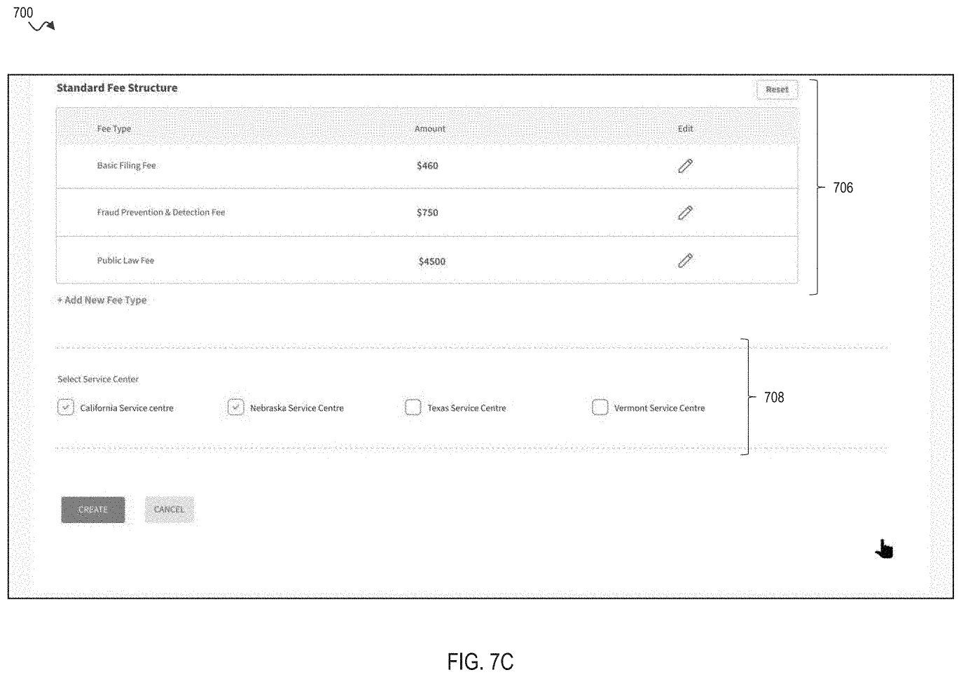

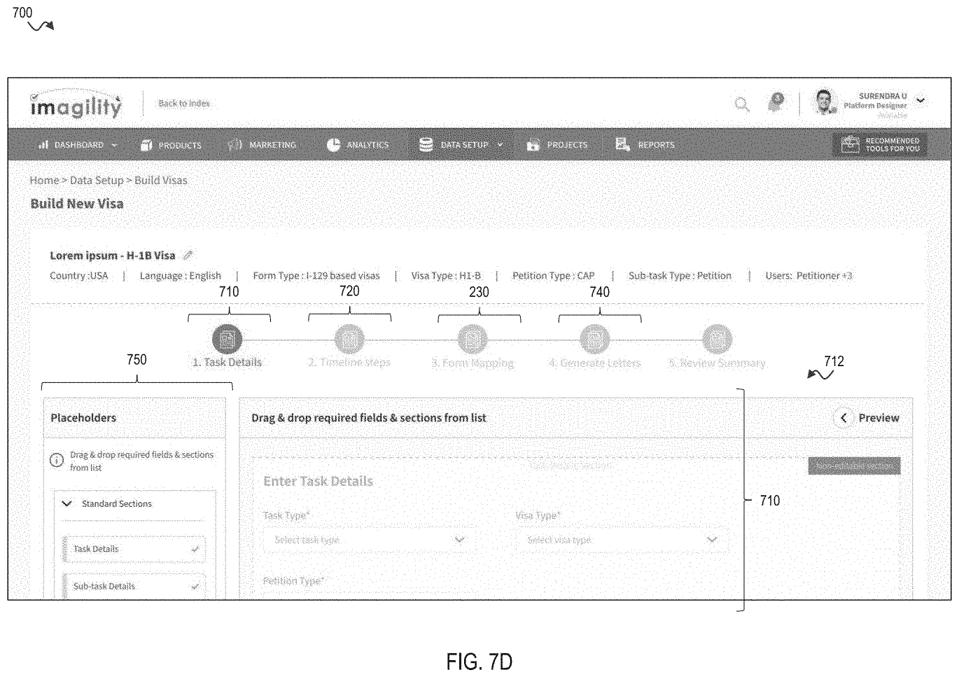

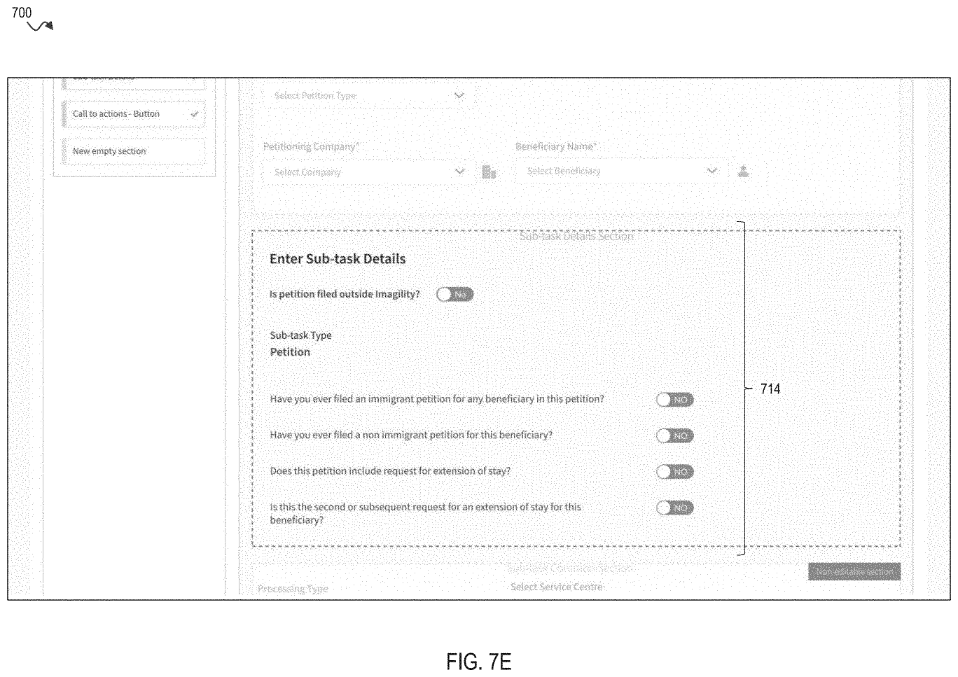

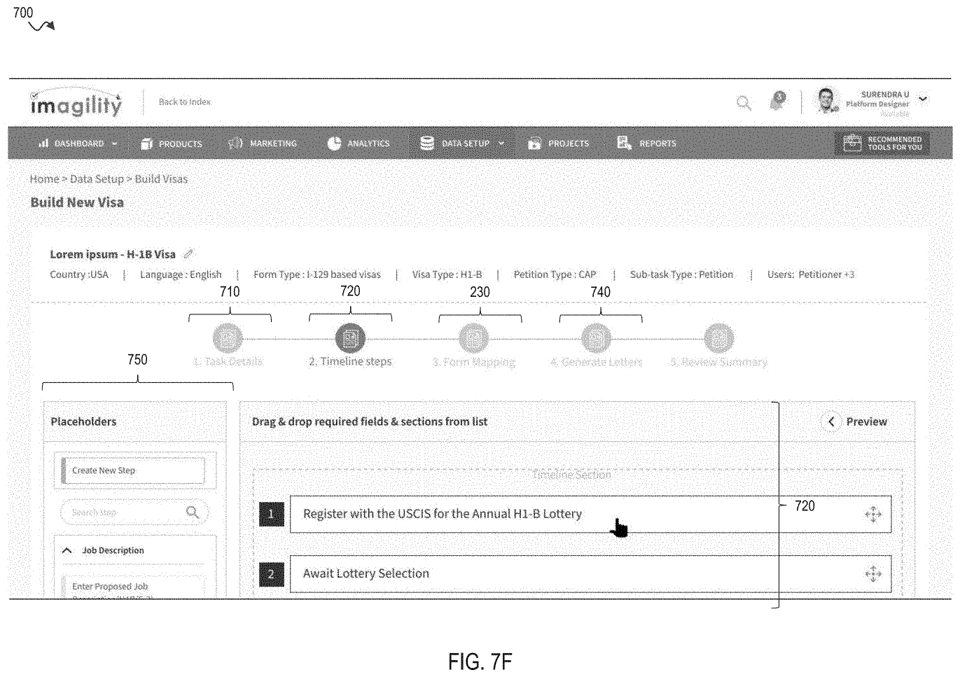

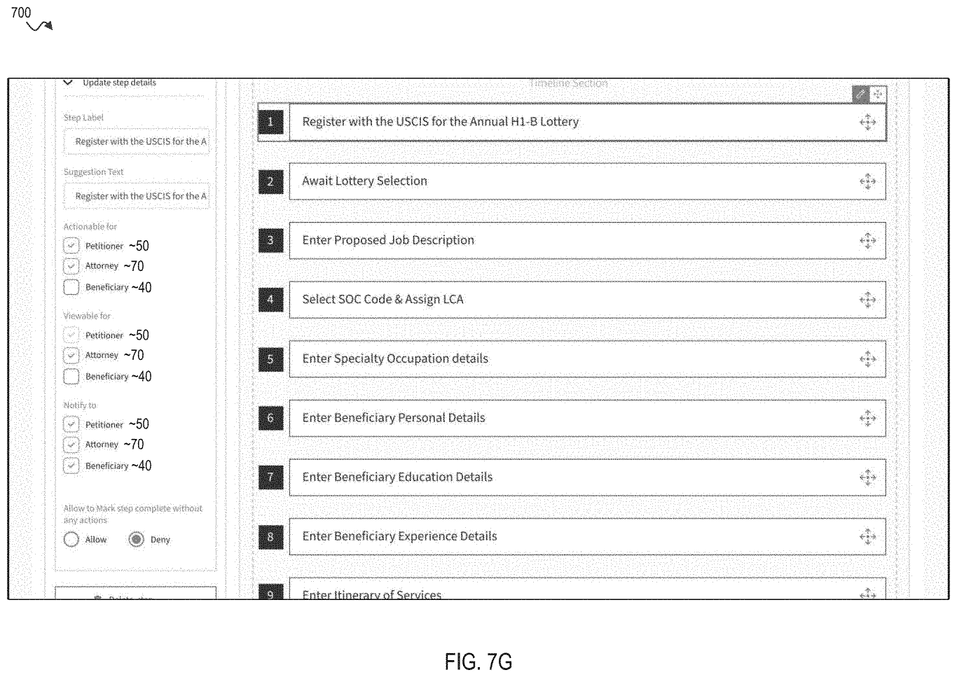

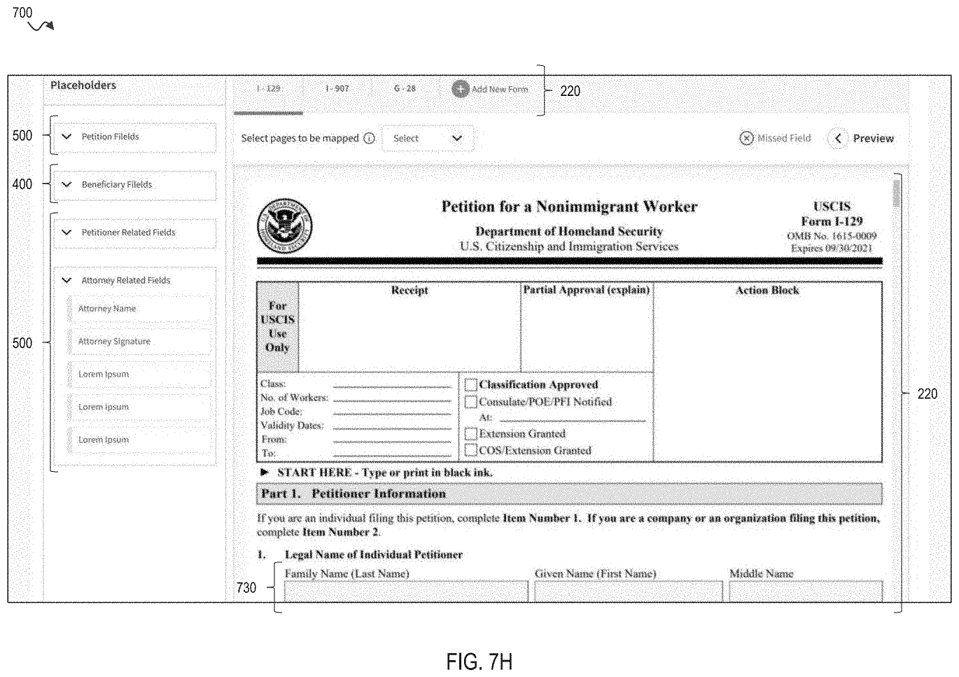

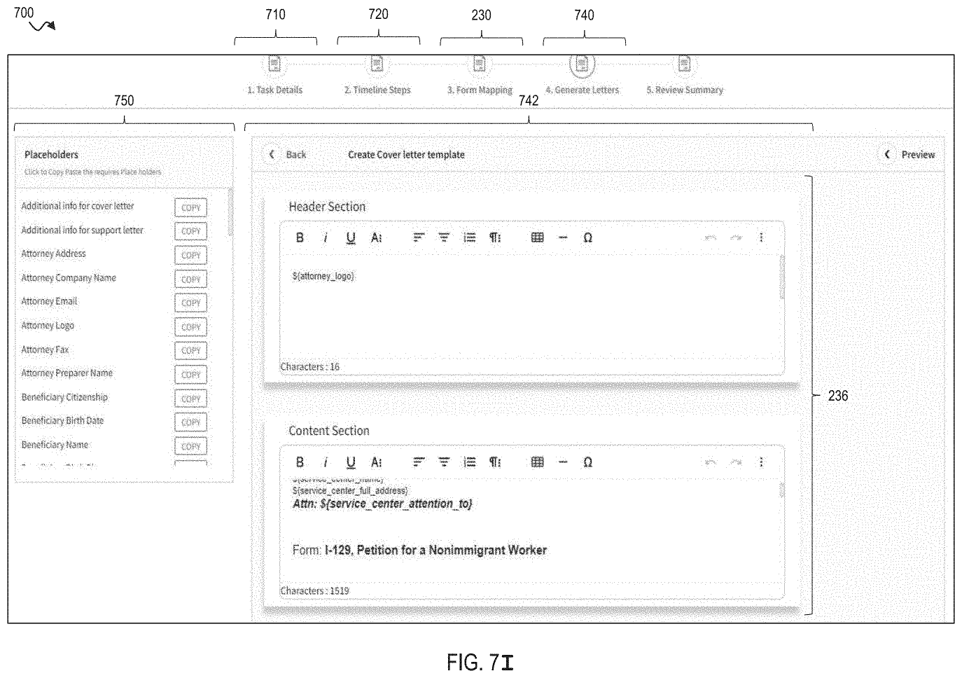

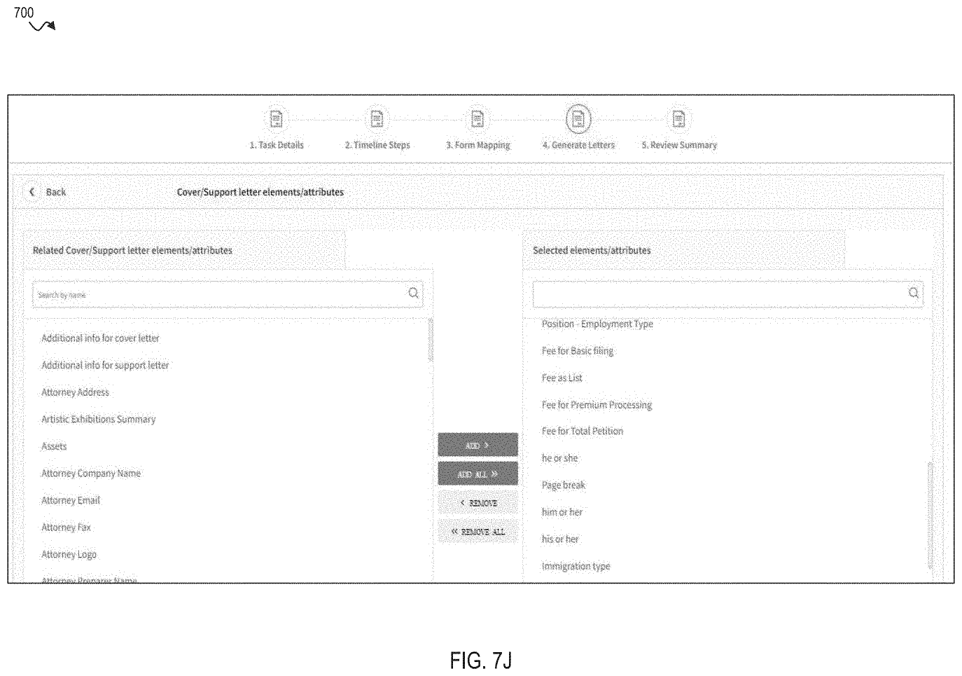

The petition generation module 300 includes a beneficiary UI 234, a petitioner UI 235, an attorney UI 237, and a form mapping module 230. As described in detail below with reference to FIGS. 4A-4D, the beneficiary UI 234 provides functionality (e.g., via a user device 120) for beneficiaries 40 to provide beneficiary data 400. As described in detail below with reference to FIGS. 5A-5F, the petitioner UI 235 provides functionality (e.g., via a user device 120) for petitioners 50 to provide petition data 500. Similarly, the attorney UI 237 provides functionality (e.g., via a user device 120) for attorneys 70 to provide petition data 500 and subject matter paragraphs 236. As described in detail below with reference to FIGS. 7H-7J, the form mapping module 230 maps the beneficiary data 400 and the petition data 500 to visa and immigration forms 220 and the subject matter paragraphs 236 to generate immigration and visa petitions.

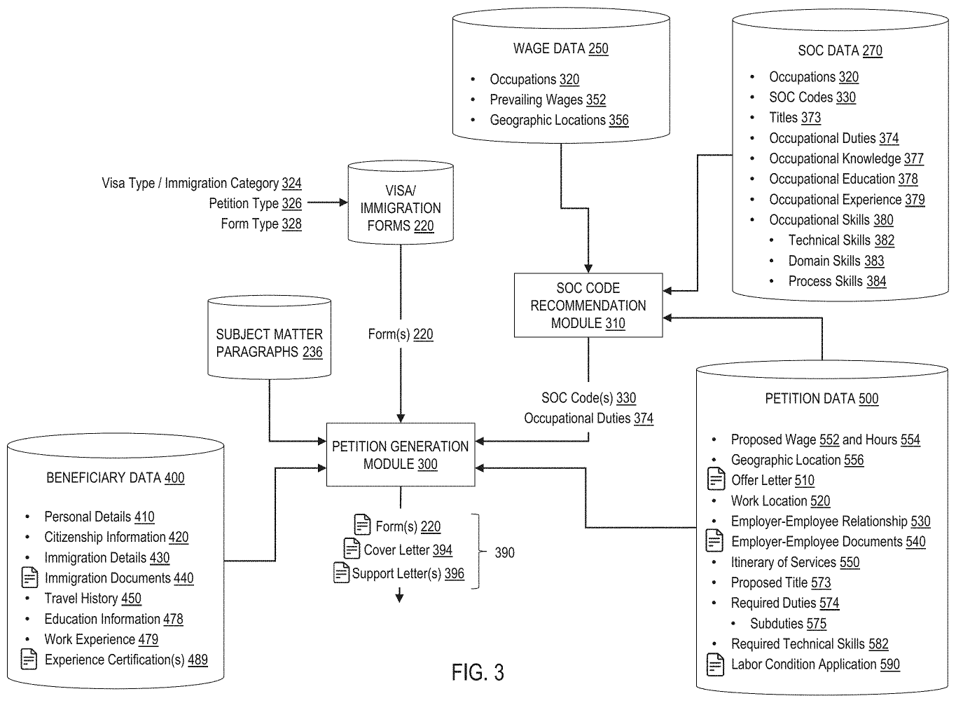

As described in more detail below with reference to FIG. 3, in some embodiments the system 200 includes an SOC code recommendation module 310 that uses wage data 250 and SOC data 270 to analyze the beneficiary data 400 and the petition data 500 and recommend occupations for the petition generation module 300 to specify in petitions for petitioners 50 on behalf of beneficiaries 40.

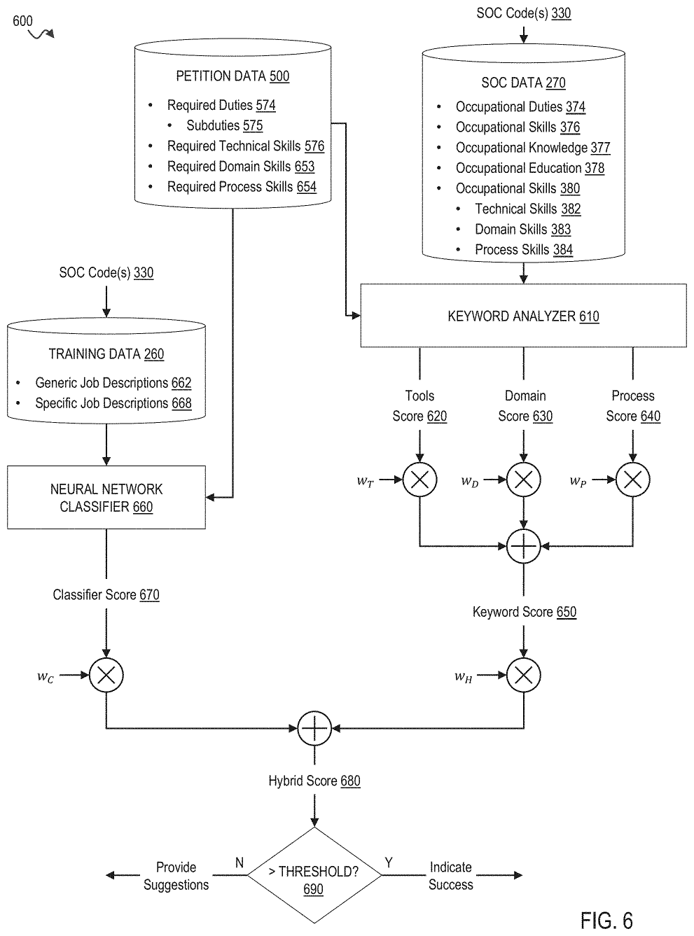

As described in detail below with reference to FIG. 6, the petition analysis module 600 uses machine learning (trained using training data 260) and keyword detection to analyze the petition data 500 and the beneficiary data 400, estimate the probability of successfully obtaining a visa or immigration adjudication, and, in some embodiments, identify deficiencies in the beneficiary data 400 and/or petition data 500 that can be revised to improve the likelihood of success.

As described in detail below with reference to FIGS. 7A-7J, in some embodiments the petition generation module 300 includes a drag-and-drop visa workflow designer 700 that provides a drag-and-drop user interface for a designer to create custom workflows for each visa type and immigration category, including tasks to be performed (by each of the beneficiary 40, the petitioner 50, and the attorney 70), timeline steps for the entire visa and immigration petition process, and form mapping 230 and letter generation for the specific visa type or immigration category.

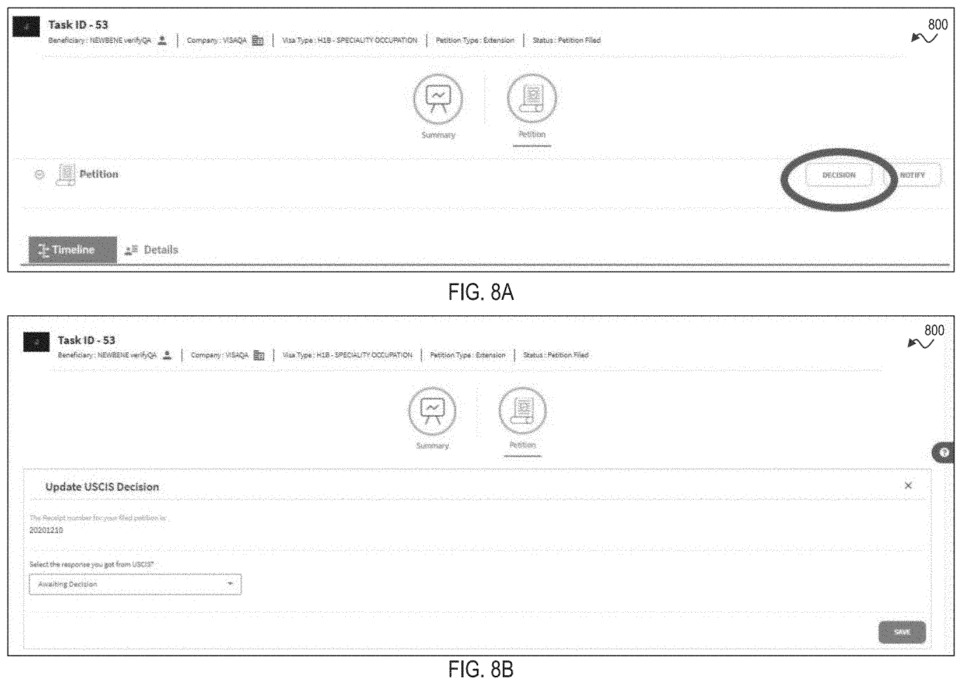

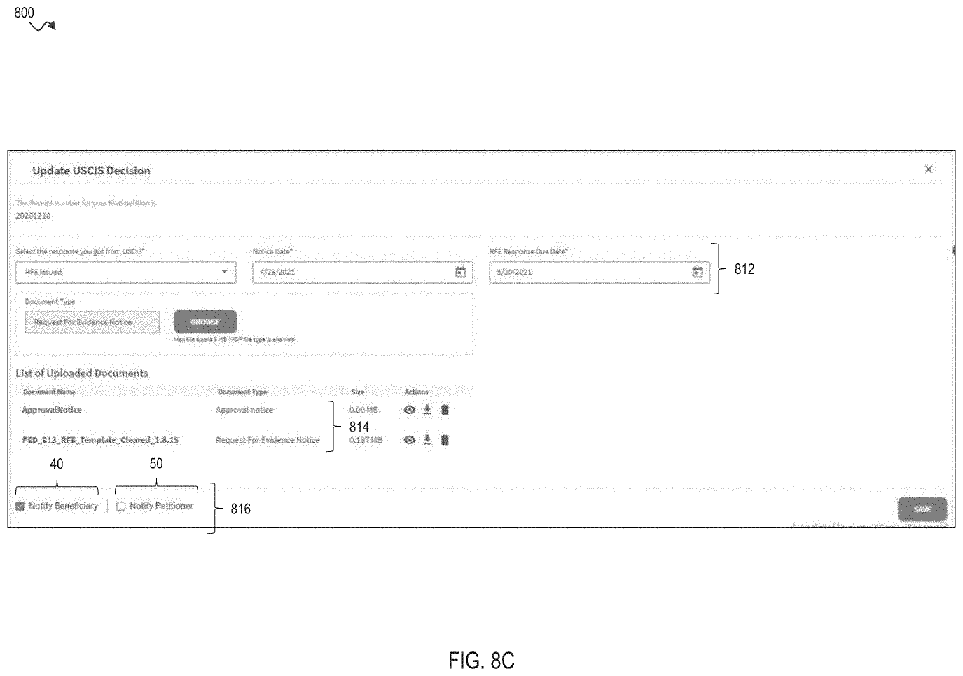

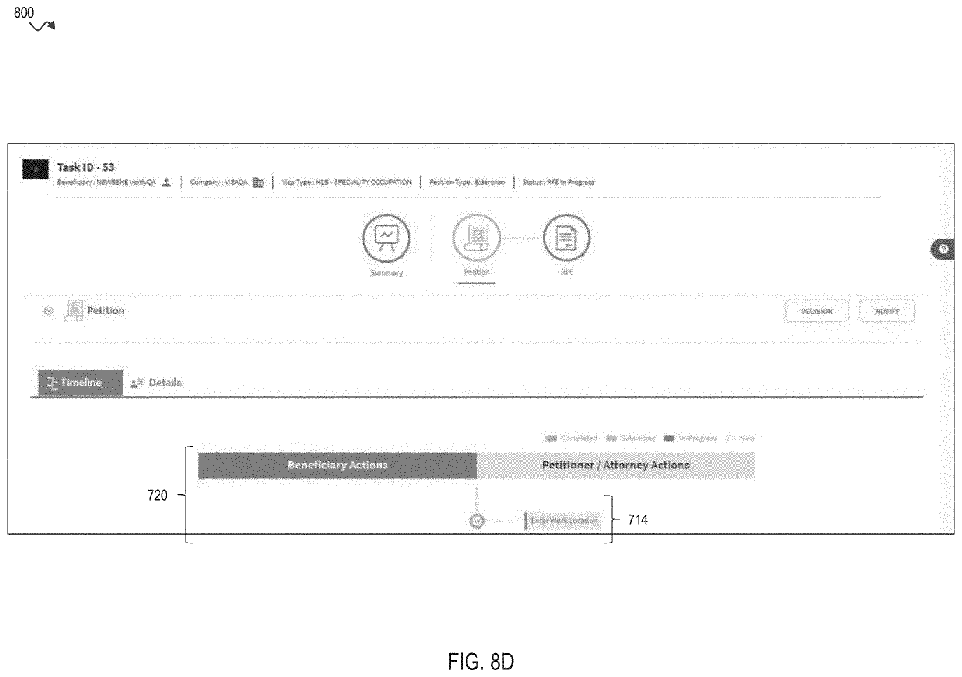

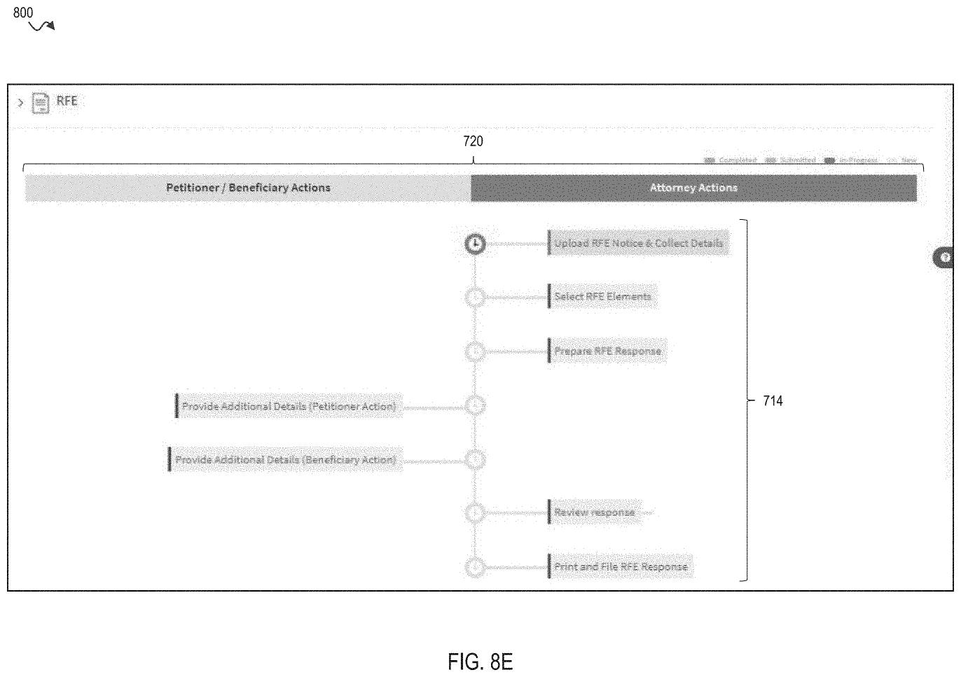

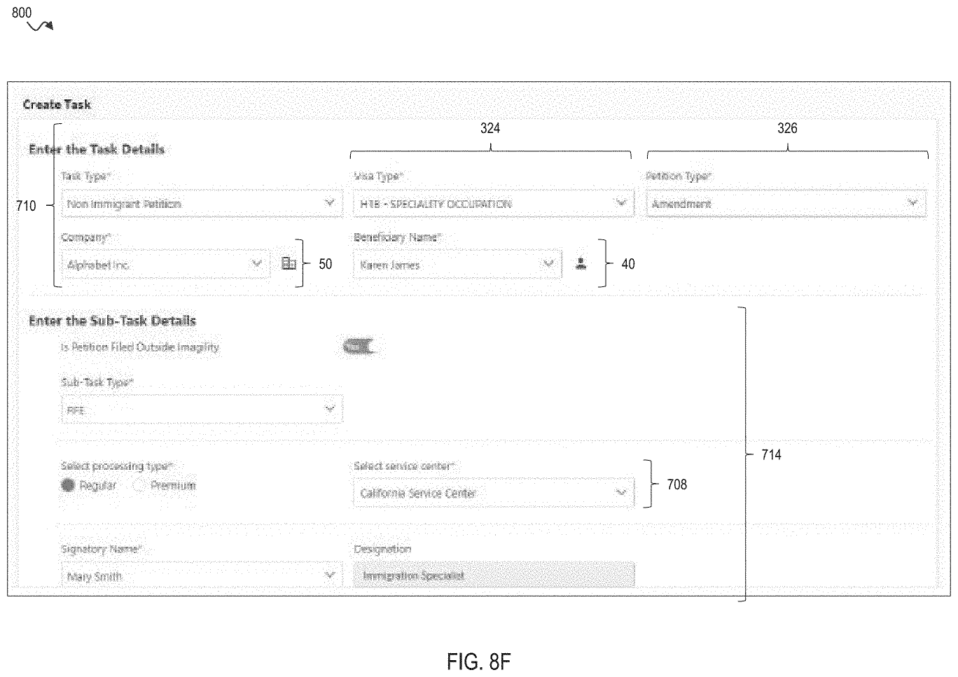

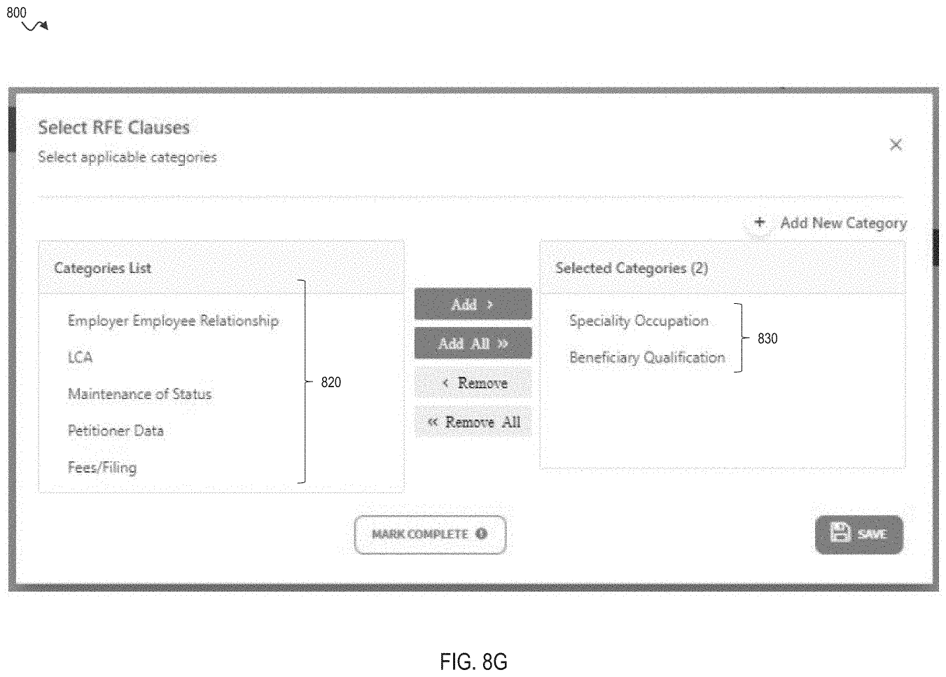

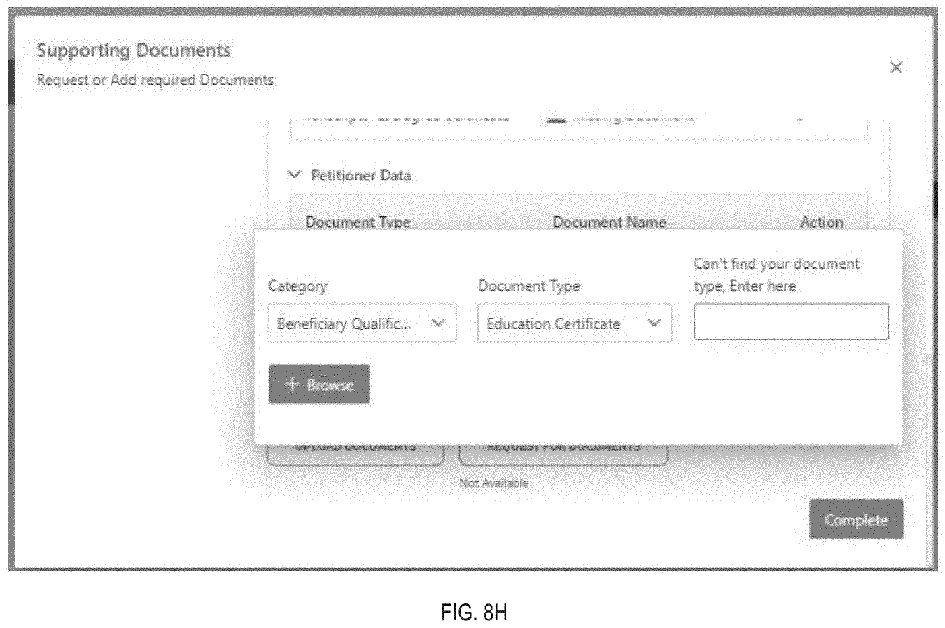

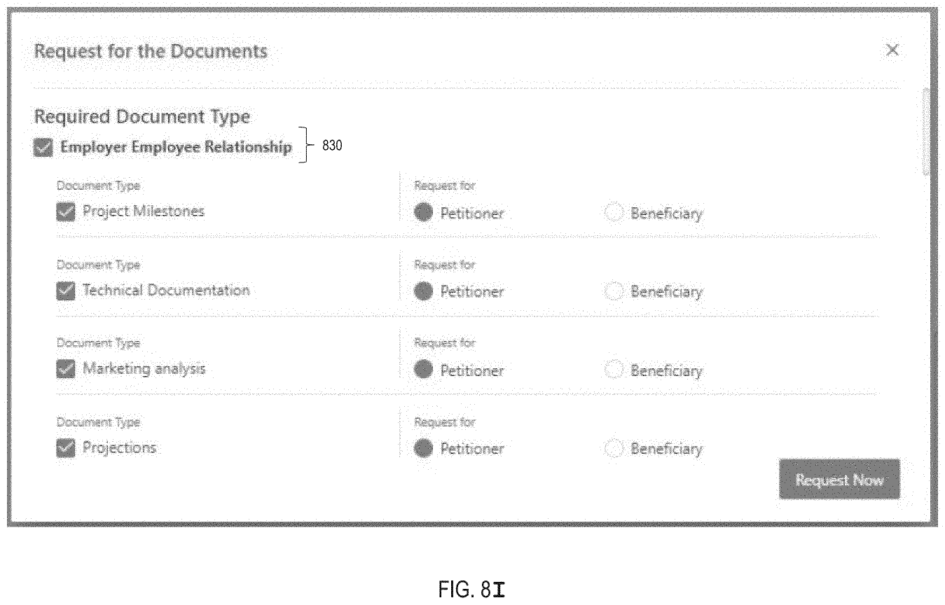

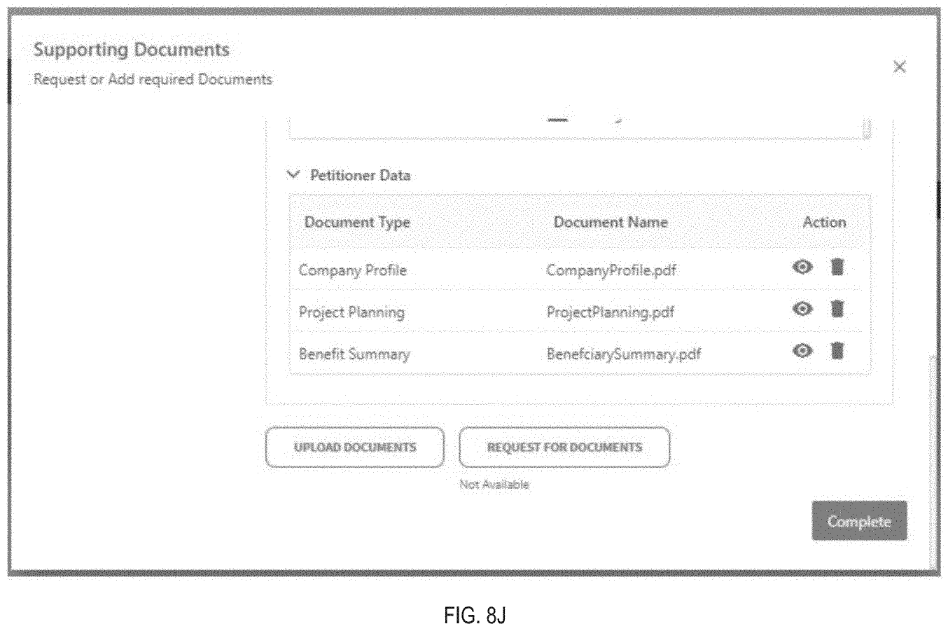

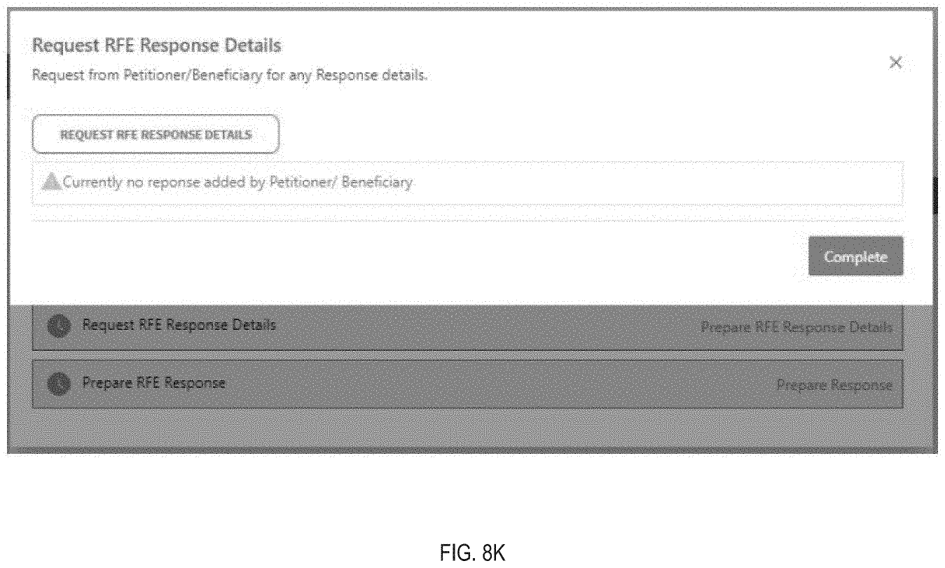

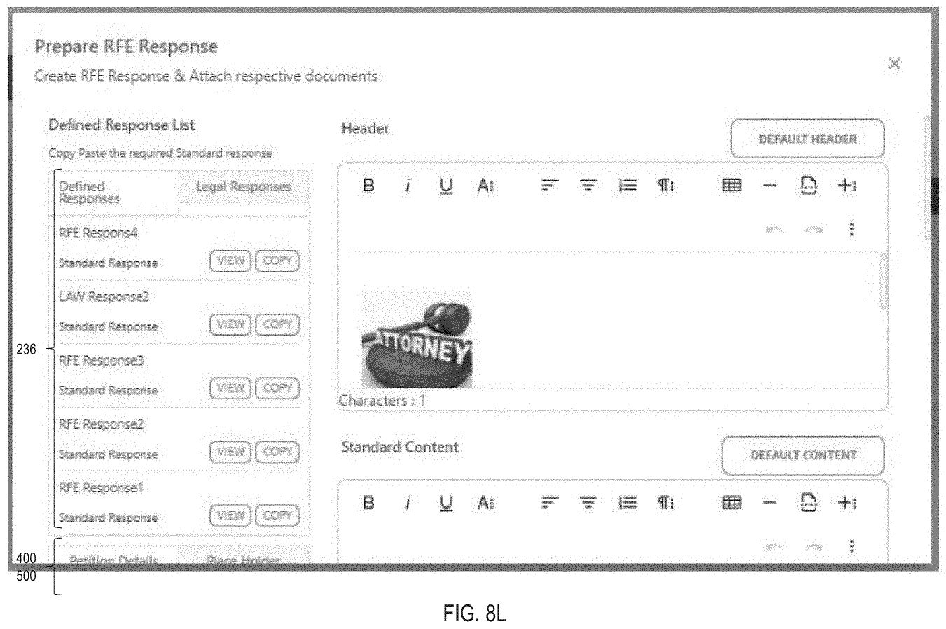

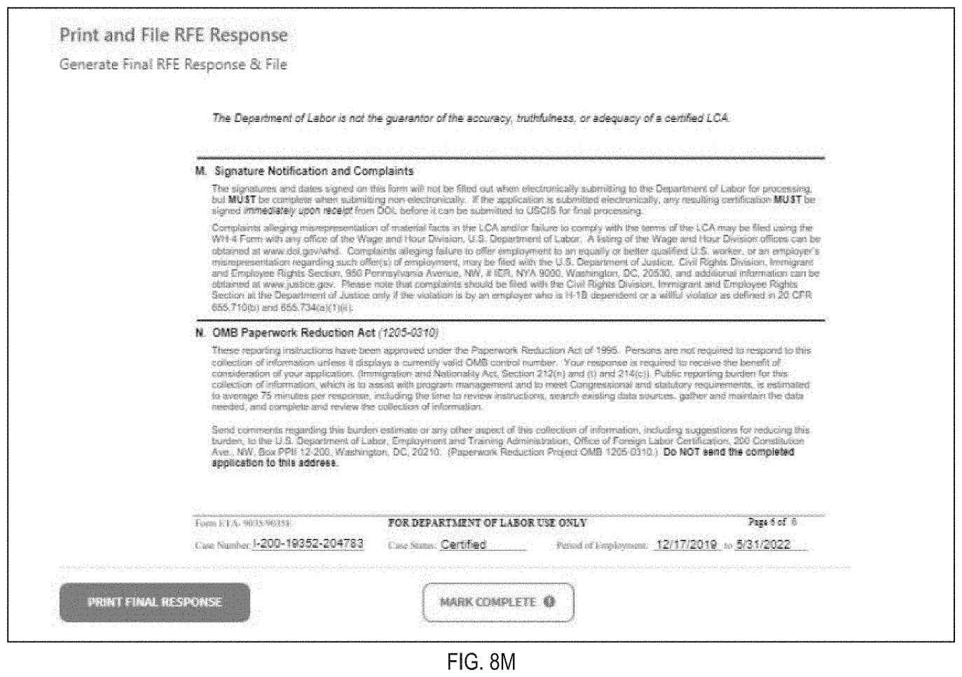

As described in detail below with reference to FIGS. 8A-8M, in some embodiments the system 200 includes an RFE response builder that provides functionality for attorneys 70 to quickly and efficiently request information and documents from beneficiaries 40 and petitioners 70 and generate responses to requests for additional evidence.

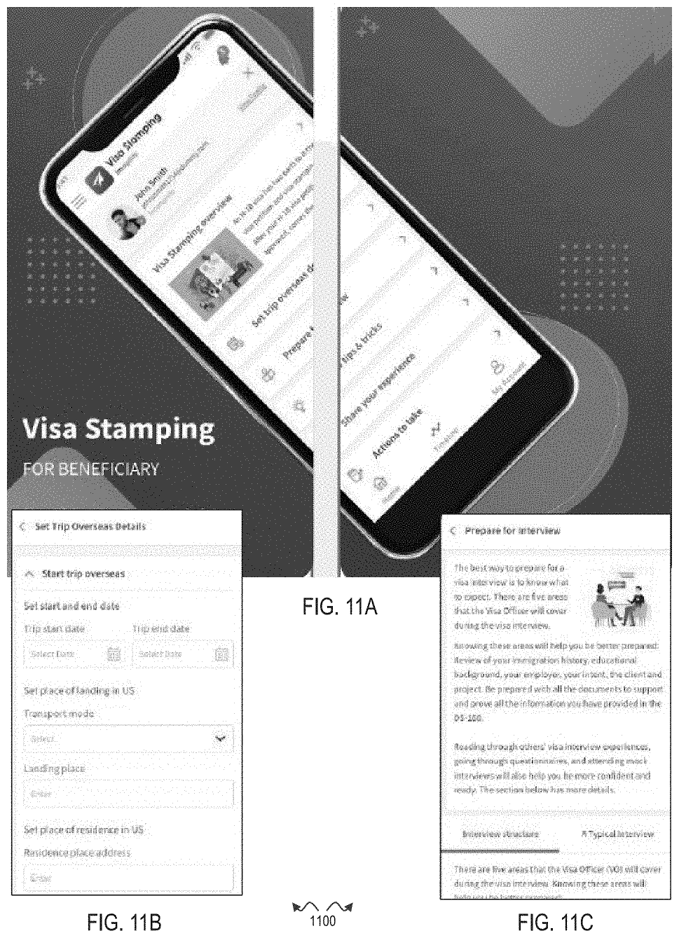

As described in detail below with reference to FIG. 11, in some embodiments the system 200 includes a visa stamping user interface 1100 that prepares beneficiaries 40 for the interview process, stores visa stamping data 210 that includes the outcomes of interviews, and provides information to future beneficiaries 40 to increase the likelihood of successfully obtaining a visa.

### Petition Generation

FIG. 3 is a block diagram of the SOC code recommendation module 310 and the petition generation module 300 according to an exemplary embodiment.

As shown in FIG. 3, the petition generation module 300 uses the beneficiary data 400 (provided, e.g., by the beneficiary 40), the petition data 500 (provided, e.g., by the petitioner 50 and/or attorney 70), and the subject matter paragraphs 236 (provided, e.g., by the attorney 70) to generate a visa or immigration petition 390 that includes visa/immigration forms 220, a cover letter 394, and one or more support letters 396. More specifically, to generate a petition 390 for a visa type or immigration category 324 requiring a petition type 326 and a form type 328, the petition generation module 300 selects one or more visa/immigration forms 220 (based on the visa type or immigration category 324, the petition type 326, and the form type 328), populates those selected visa/immigration forms 220 using the beneficiary data 400 and the petition data 500 (as described in detail below with reference to FIG. 7I), and generates a cover letter 394 and one or more support letters 396 that include the subject matter paragraphs 236 as well as the beneficiary data 400, the petition data 500, and supporting documents.

As described in more detail below with reference to FIG. 4, the beneficiary data 400 includes information and documents regarding the beneficiary 40, for example including personal details 410, citizenship information 420, immigration details 430, immigration documents 440, travel history 450, education information 478, work experience 479, one or more experience certifications 489, etc.

As described in more detail with reference to FIGS. 5A-F, the petition data 500 for employment-based petitions 390 includes information and documents regarding the proposed position, for example including the proposed wage 552 and hours 554, the geographic location 552 of the position, an offer letter 510, the work location 520 (e.g., on site or at a third-party site), the employer-employee relationship 530 (e.g., employee, contractor, etc.), employer-employee relationship documents 540, an itinerary of services 550, the proposed title 573, proposed duties 574 and subduties 575 of the position, the required technical skills 582 for the position, the labor condition application 590 of the petitioner 50, etc.

The 2018 Standard Occupational Classification (SOC) system is a federal statistical standard used by federal agencies to classify workers into occupational categories of specific occupations having similar job duties (and, in some cases skills, education, and/or training). In the SOC system, each occupation 320 is assigned an SOC code 330. For employment-based immigration, the proposed position must qualify as a “specialty” occupation 320 and the beneficiary must be qualified to fill that specialty occupation 320. Accordingly, selecting an SOC code 330 of a qualifying occupation 320 that can be supported by the petition data 500 and the beneficiary data 400 if vitally important to maximizing the likelihood of an employment-based petition 390 being granted. Therefore, in some embodiments, the system 200 includes an SOC code recommendation module 310 that uses wage data 250 and SOC data 270 to analyze the beneficiary data 400 and the petition data 500 and recommend an occupational category for use by the petition generation module 300 when generating a petitions for a petitioner 50 on behalf of a beneficiary 40.

For each of a plurality of occupations 320, the wage data 250 includes the prevailing wage 352 in each of a number of geographic locations 356. The wage data 250 may be received from a third-party source 130, such as the U.S. Department of Labor Foreign Labor Certification Data Center.

For each of the occupations 320, the SOC data 270 includes the SOC code 330, a title 373, occupational duties 374, required occupational knowledge 377, required occupational education 378, required occupational experience 379, the required occupational skills 380, etc. In some embodiments, the SOC data 270 may include required skills 380 in a number of categories, such as technical skills 382, domain skills 383, and process skills 384. Technical skills 382 may include, for example, specialized knowledge required to use the technological tools commonly used in the occupation 320. Domain skills 383 may include, for example, domain-specific knowledge (e.g., developing software for a particular industry, Medicaid/Medicare eligibility, etc.) specific to the industry of the occupation. Similarly, process skills 384 may include, for example, familiarity with domain-specific processes in the industry of of the occupation 320. The SOC data 270 may include information received from a third-party source 130, such as the O*NET OnLine from the U.S. Department of Labor, the Occupational Outlook Handbook from the U.S. Bureau of Labor Statistics, etc.

As shown in FIG. 3, the SOC code recommendation module 310 uses pattern recognition to identify the SOC code(s) 330 of one or more occupations 320 based on the petition data 500. For example, the SOC code recommendation module 310 may use natural language processing to parse the required duties 574 (and, if available, the subduties 575) in the petition data and identify one or more occupations 320 having similar occupational duties 374. For example, the SOC code recommendation module 310 may make a probabilistic determination of the occupations 320 having the closest matching occupational duties 374 and output a ranked list SOC codes 330.

FIGS. 4A through 4D illustrate views of the beneficiary UI 234, which provides functionality (e.g., for beneficiaries 40) to input beneficiary data 400 according to an exemplary embodiment.

As shown in FIGS. 4A through 4D, the beneficiary UI 234 provides functionality (e.g., for beneficiaries 40) to input information and upload documents regarding the beneficiary 40, for example including personal details 410, citizenship information 420, and immigration details 430 (e.g., as shown in FIG. 4A), immigration documents 440 (e.g., as shown in FIG. 4B), education information 478 (e.g., as shown in FIG. 4C), work experience 479 (e.g., as shown in FIG. 4D), etc.

FIGS. 5A through 5F illustrate views of the petitioner UI 235 and/or the attorney UI 237, which provide functionality (e.g., for beneficiaries 40 and/or attorneys 70) to input petition data 500 according to an exemplary embodiment.

As shown in FIGS. 5A through 5F, for employment-based petitions 390, the petitioner UI 235 and/or the attorney UI 237 provide functionality (e.g., for beneficiaries 40 and/or attorneys 70) to input information, for example including the work location 520 (e.g., on site or at a third-party site) and the geographic location 552 of the position (e.g., as shown in FIG. 5A), the proposed title 573, the proposed wage 552, and the proposed hours 554 (e.g., as shown in FIG. 5B), the proposed duties 574 (and subduties 575) of the position (e.g., as shown in FIG. 5C), the employer-employee relationship 530 (e.g., as shown in FIG. 5C), and functionality to upload documents regarding the proposed position, for example including employer-employee relationship documents 540 (e.g., as shown in FIG. 5F).

The system 200 may store default lists of required job duties 574 for a number of occupations 320. In those embodiments, as shown in FIG. 5C, the petitioner UI 235 and/or the attorney UI 237 may provide functionality for the user to select an occupation 320 and view the stored job duties 574 for the selected occupation 320. As briefly mentioned above, the likelihood of an employment-based petition 390 being granted is largely affected by whether the for the position match the occupational duties 374 of a specialty occupation 320. Accordingly, the stored job duties 574 for each specialty occupation 320 may be identical to or derived from the occupational job duties 374 of those specialty occupations 320. As shown in 5D, the petitioner UI 235 and/or the attorney UI 237 may provide functionality for the user to view the occupational duties 374 specified in the DOC data 270 for the selected SOC code 330.

Additionally, as shown in FIG. 5D, the petitioner UI 235 and/or the attorney UI 237 provides functionality for the user to match each of the required job duties 574 input by the user to one of the occupational duties 374 specified in the DOC data 270 for the selected SOC code 330. Accordingly, when generating a support letter 396 (e.g., as described above with reference to FIG. 3 and below with reference to FIGS. 7I-7J), the petition generation module 300 can generate a draft argument that the position qualifies as the specialty occupation 320 associated with the selected SOC code 330 because the position includes job duties 574 that match each of the specified occupational duties 374 as indicated by the user.

### Rules Engine

As described above with reference to FIGS. 2-3, the petition building module 300 populates visa/immigration forms 220 with the beneficiary data 400 and the petition data 500 and generates cover letters 394 and support letters 396 that include subject matter paragraphs 236 input by the user as well as the beneficiary data 400 and the petition data 500. Meanwhile, as shown in FIG. 2, in some embodiments the system 200 includes a rules engine 240 that stores rules for identifying a lack of information or documents required to generate the specified petition 390 (for example, petitioner data 400 includes travel history 450 but does not include a valid visa). Additionally or alternatively, the rules engine 240 may store rules for identifying conflicting data, even across different domains, in the beneficiary data 400 and the petition data 500 (e.g., the petition data 500 indicates that the petitioner 50 has attributes that conflict with the selected fee structure for the petition 390). By using rules and rule bundles to process and compare the beneficiary data 400 and the petition data 500, the rules engine 240 ensures that the petition building module 300 has the correct data to generate the petition 390 for the selected visa type or immigration category 324, the petition type 326, and the selected occupation 320.

### Neural-Network Enabled Petition Analysis

Referring back to FIG. 2, in addition to generating petitions 390 using the beneficiary data 400 and the petition data 500, the system 200 also includes a neural network-enabled petition analysis module 600 that analyzes the beneficiary data 400 and the petition data 500 used to generate those petitions 390 and estimates the likelihood of the petition 390 being granted. To do so, the system 200 stores indications of whether petitions 390 generated by the system 200 are granted or denied in the training data 260. Meanwhile, the petition analysis module 600 includes a neural network that is trained on the beneficiary data 400 and the petition data 500 used to generate previous petitions 390 (that are labeled as being granted or denied) to develop a model for estimating, based on the beneficiary data 400 and the petition data 500 used to generate future petitions 390, the likelihood that those future petitions 390 will be granted or denied.

To estimate the likelihood that a petition 390 will be granted, the petition analysis module 600 may determine a score S for each determination I in each of n categories C and arrive at a final score Z as follows

$$Z = {\sum }_{i = 1}^{n} ( S [ I [ C [ i ] ] ] )$$

That final score Z may be adjusted to 800 as follows

Zscore=Z*Z/800

The determinations I in each of the n categories C may include, for example, whether the petition 390 identifies the proper fee for the petitioner 50, whether the beneficiary data 400 and/or the petition data 500 includes sufficient documentation (e.g., immigration documents 440, experience certifications 489, an offer letter 510, employer-employee relationship documents 540, etc.) to support the information provided, whether the selected SOC code 330 corresponds to a specialty occupation 320, whether the selected SOC code 330 corresponds to the Labor Condition Application 590 obtained by the petitioner 500, whether the beneficiary 40 has previously maintained his or her employment and H-1B status, whether the work location 520 is on site (in which case the petition 390 may be more likely to be granted) or at a third-party site in which case the petition 390 may be less likely to be granted, whether the employer-employee relationship 530 is that of an employee (in which case the petition 390 may be more likely to be granted) or a contractor (in which case the petition 390 may be less likely to be granted), whether the beneficiary 40 is qualified (e.g., based on educational background 478 or work experience 479) for the specialty occupation 320, etc.

To determine the determinations I (e.g., whether the work location 520 is on site or at a third-party site) in each category C (e.g., the work location 520) that are predictive of the petition 390 being granted (and the score S indicative of each increase or decrease in the likelihood of the petition 390 being granted), the neural network is trained using the training data 260 as described above. Using the formulas above, for instance, the neural network may make determinations I and identify scores S for each determination I (in each of n categories C) such that the Zscore for each past petition 390 in the training data 260 is indicative of the likelihood that the past petition 390 was accepted or denied.

While determinations I in certain categories C and may be relevant to the likelihood of that any petition 390 will be granted, the neural network may determine that some determinations I are uniquely predictive of whether petitions 390 having certain visa types or immigration categories 324 are likely to be granted. For family, humanitarian, and naturalization immigration, for example, the factors may be completely different and may include, for instance, eligibility initially or continually (in the case of the death of a sponsor or the occurrence of an inadmissibility event). Accordingly, in some embodiments, the neural network may identify unique scores S for determinations I in each of a plurality of different visa types and immigration categories 324.

The Zscore and may be output to the user (e.g., the attorney 70), enabling the user to understand the likelihood of the petition 390 being granted. Additionally, the determinations I made in each category C may be output to the user, enabling the user to understand the steps that can be taken to improve the likelihood of the petition 390 being granted (e.g., hiring the beneficiary 40 as an employee, making the work location 520 on site, revising the job description, etc.).

Accordingly, in addition to providing functionality for users to quickly and efficiently generate petitions 390, the neural network-enabled system 200 estimates the likelihood of each generated petition 390 being granted, enabling users to determine whether each generated petition 390 is in condition for filing or whether the petitioner 50 (and the beneficiary 40) are better served revising the petition 390 and increasing the likelihood of obtaining the requested visa or immigration adjudication.

In addition to the determinations I described above, another factor that greatly influences whether an employment-based petition 390 is likely to be granted is the specificity of the job description in the petition data 500 and the number of skills required for the position.

FIG. 6 is a block diagram of a process, performed by the petition analysis module 600, for determining the specificity of the job description in the petition data 500 the number of skills required for the position according to an exemplary embodiment.

Because petitions 390 are more likely to be granted if the job description is specific rather than generic, the petition analysis module 600 includes a neural network classifier 660 that analyzes the required duties 574 and subduties 575 included in the petition data 500 and outputs a classifier score 670 indicative of the specificity of the job description. To generate the classifier score 670, the neural network 660 is trained to develop a sigmoid function using training data 260 that includes job descriptions for each of a number of SOC codes 330 that have been coded as generic 662 and specific 668. Additionally, in some embodiments, when petitions 390 generated by the system 200 are granted or denied, the job descriptions from those petitions 390 may be added to the training data 260. Accordingly, job descriptions from petitions 390 that have been granted and denied are used to further refine the neural network 660 to better identify specific job descriptions that are likely to lead to the petition 390 being granted and generic job descriptions that may need to be revised.

The likelihood of an employment-based petition 390 being granted is also influenced by the number of skills required for the position. Accordingly, the petition analysis module 600 may include a keyword analyzer 610 that identifies keywords in the petition data 500 and generates a keyword score 650 indicative of the number of required skills for the position. In the embodiment of FIG. 6, the keyword analyzer 610 generates a tools score 620 indicative of the number of technical skills 582 required for the position, a domain score 630 indicative of the number of domain skills required for the position, and a process score 640 indicative of the number of process skills required for the position.

The keyword analyzer 610 may perform a keyword search of the petition data 500 for terms included in the SOC data 270 for the occupation 320 that corresponds to the selected SOC code 330 (and/or synonyms those terms). To generate the tools score 620, for instance, the keyword analyzer 610 may do a keyword search for the technical skills 382. Similarly, to generate the domain score 630 and the process score 640, the keyword analyzer 640 may perform keyword searches for the domain skills 383 and the process skills 384. The technical skills 382 required for the occupation 320 may be identified, for example, in the O*Net Online description of the occupation 320. Additionally, in the embodiment of FIG. 6, the SOC data 270 also includes domain skills 383 and process skills system 200 for the occupation 320 corresponding to the SOC code 330.

The tools score 620, the domain score 630, and the process score 640 are summed to form a keyword score 650 indicative of the number of skills required for the occupation 320. The classifier score 670 and the keyword score 650 are summed to form a hybrid score 680, which is compared to a threshold 690. The tools score 620, the domain score 630, the process score 640, the keyword score 650, and the classifier score 670 are all weighted by tunable weights w.

If the hybrid score 680 meets or exceeds the threshold 690, the petition analysis module 600 outputs an indication to the user that the job description is likely to be sufficient to qualify as a specialty occupation 320. If the hybrid score 680 is less than the threshold 690, the petition analysis module 600 outputs an indication to the user that the job description is unlikely to be sufficient to qualify as a specialty occupation 320. In some embodiments, the petition analysis module 600 outputs suggestions for improving the job description (e.g., by adding more of the technical skills 382, the process skills 383, and the process skills 383 listed in the SOC data 270 for the occupation 320) and increasing the likelihood that the job description is unlikely to be sufficient to qualify as a specialty occupation 320.

### Drag-and-Drop Visa Workflow Designer

FIGS. 7A through 7G are views of the drag-and-drop visa workflow designer 700 according to an exemplary embodiment.

While conventional systems allow practitioners to populate visa and immigration forms 220, the visa workflow designer 700 enables a designer to create custom workflows for each visa type and immigration category 324, including tasks 710 to be performed (by each of the beneficiary 40, the petitioner 50, and the attorney 70), timeline steps 720 for the entire visa and immigration petition process, and form mapping 230 and letter generation 740 (e.g., a cover letter 394 and support letter(s) 396, etc.) for the specific visa type or immigration category 324. As shown in FIG. 7A, the visa builder 700 provides functionality for designers to create new visa workflows 701 and manage existing visa workflows 701. To build a new visa workflow 701, the visa builder 700 provides functionality to select the country 702, the language 704, the form type 328, the visa type or immigration category 324, and the petition type 326, for example as shown in FIG. 7B. As shown in FIG. 7C, the system identifies the fee structure 706 and available service centers 708 for the selected visa type (or immigration category) 324 and the selected petition type 326. To do so, the system 200 stores the fee structures 706 and available service centers 708 for each combination of visa type 324 and petition type 326. The visa builder 700 provides functionality for the designer to select the service centers 708 available to end users (e.g., petitioners 50 and attorneys 70).

As shown in FIGS. 7D-7E, the drag-and-drop user interface 712 allows the designer to quickly and easily define specific tasks 710 (and subtasks 714) to be performed by each of the beneficiary 40, the petitioner 50, and the attorney 70 for the specified visa type or immigration category 324. Additionally, the visa workflow designer 700 enables the tasks 710 that are common across multiple visa types or immigration categories 324 to be stored as placeholders 750 that can easily be added to other visa workflows 701 for other visa types or immigration categories 324 by dragging and dropping those placeholders 750.

As shown in FIGS. 7F-7G, the drag-and-drop user interface 712 of the visa workflow designer 700 enables the designer define timeline steps 720 that mark the entire visa and immigration process for the specified visa type or immigration category 324. Again, the visa workflow designer 700 enables timeline steps 720 that are common across multiple visa types or immigration categories 324 to be stored as placeholders 750 that can easily be added (by dragging and dropping those placeholders 750) to other visa workflows 701 for other visa types or immigration categories 324. As shown in FIG. 7G, the visa workflow designer 700 enables the designer to specify whether each timeline step 720 is actionable or viewable by the beneficiary 40, the petitioner 50, and/or the attorney 70 (and whether the beneficiary 40, the petitioner 50, and/or the attorney 70 will be notified of each timeline step 720).

As shown in FIG. 7H, the visa workflow designer 700 enables the designer to select the relevant visa and immigration form(s) 220 for the specified visa type or immigration category 324 and configure the form mapping module 230 to map the beneficiary data 400 and the petition data to the relevant fields 730 of the visa and immigration form(s) 220.

As shown in FIG. 7I, the visa workflow designer 700 enables the designer to create document templates 742 (e.g., a cover letter 394, support letter(s) 396, etc.) with subject matter paragraphs 236 for the specified visa type or immigration category 324. Again, the visa workflow designer 700 enables subject matter paragraphs 236 that are common across multiple visa types or immigration categories 324 to be stored as placeholders 750 that can easily be added (by dragging and dropping those placeholders 750) to other document templates 742 for other visa types or immigration categories 324. As shown in FIG. 7J, the visa workflow designer 700 enables the designer to specify and add the placeholders 750 that are relevant to the specified visa type or immigration category 324.

As briefly mentioned above, the visa workflow designer 700 includes functionality that allows the users to generate petitions 390 that are more likely to be granted. For certain occupations 320, for example, the visa workflow designer 700 stores objects developed to implement specific subject matter steps, map information to forms 220, include information in support letters 396, etc. As described above with reference to FIG. 5C, for instance, the system 200 may provide functionality for the user to select an occupation 320 and view the stored job duties 574 for the selected occupation 320. Because the likelihood of an employment-based petition 390 being granted is largely affected by whether the for the position match the occupational duties 374 of a specialty occupation 320, the stored job duties 574 for each specialty occupation 320 may be identical to or derived from the occupational job duties 374 of those specialty occupations 320. Meanwhile, as described above with reference to FIG. 5D, the system 200 may provide functionality for the user to match each of the required job duties 574 input by the user to one of the occupational duties 374 specified in the DOC data 270 for the selected SOC code 330 and generate a support letter 396 with a draft argument that the position qualifies as the specialty occupation 320 associated with the selected SOC code 330 because the position includes job duties 574 that match each of the specified occupational duties 374 as indicated by the user. In addition to employment-based petitions, the system 200 also provides similar functionality for family, humanitarian, and naturalization petitions.

Accordingly, as described above, in addition to capturing information and filling out visa and immigration forms 220, the system 200 enables users to manage the entire visa and immigration process, including specifying tasks 710 to be performed by—and timeline steps 720 that are actionable by—each of the beneficiary 40, the petitioner 50, and the attorney 70 for each visa type or immigration category 324.

### RFE Response Generator

FIGS. 8A through 8L are view of the RFE response builder 800 according to an exemplary embodiment.

The U.S. Customs and Immigration Service (USCIS) will often respond to a visa or immigration petition 390 with a Request for Evidence (RFE) requiring additional information or documents, for example before deciding whether to grant an employment-based petition 390. Unlike when generating a visa or immigration petition 390, there are no forms 220 for preparing an RFE response. Instead, responding to an RFE often requires the user (e.g., the attorney 70) to notify the petitioner 50 and/or the beneficiary 40, gather the specific information and/or documents requested, and prepare a written response to the specific requests from scratch. Accordingly, as described below, the RFE response builder 800 identifies a timeline 720 of subtasks 714 (to be performed by the attorney 70, the petitioner 50, and/or the beneficiary 40) to respond to the RFE, enabling the user to quickly and efficiently gather the requested information and/or documents and prepare the response to the RCE.

As shown in FIGS. 8A through 8C, the RFE response builder 800 provides functionality for the user (e.g., the attorney 70) to indicate that an RFE has been issued for a petition 390. As shown in FIG. 8C, the RFE response builder 800 provides functionality to specify the due date 812 for an RFE response, upload the received documents 814, and notify 814 the beneficiary 40 and/or the petitioner 50 that the RFE has been issued.

As shown in FIG. 8D, if the RFE was issued for a petition 390 generated using the system 200 (meaning the petition data 500 and the beneficiary data 400 is already stored by the system), the RFE response builder 800 proceeds to generate a timeline 720 of subtasks 714 to be performed by the attorney 70 and the petitioner 50 or beneficiary 40. The timeline 720 and subtasks 714 for responding to RFEs may be specified and pre-stored, for example using the visa workflow designer 700 as described above with reference to FIGS. 7D-7G. If the RFE was issued for a petition 390 generated outside of the system 200, a task 710 (e.g., to complete the petition process) and a subtask 714 (e.g., to respond to the RFE) may need to be specified and petition information 500 and beneficiary information 400 may need to be input, for example as shown in FIG. 8F.

An RFE may request information and/or documents regarding specific petition information 500 (e.g., the specialty occupation 320, the employer-employee relationship 530, the labor condition application 590, etc.) and/or beneficiary information 400 (e.g., whether the beneficiary 40 is qualified for the specialty occupation 320). As shown in FIG. 8G, the RFE response builder 800 provides functionality for the user (e.g., the attorney 70) to categorize common requests 820 for evidence and select the specific requests 830 in the received RFE. As shown in FIGS. 8H through 8K, to respond to each specific request 830, the RFE response builder 800 provides functionality for the user (e.g., the attorney 70) to request documents from the beneficiary 40 and/or the petitioner 50 (e.g., as shown in FIGS. 8H-8I), and upload those documents (e.g., as shown in FIG. 8J) and request information from the beneficiary 40 and/or the petitioner 50 (e.g., as shown in FIG. 8K).

As shown in FIG. 8L, the response builder 800 provides functionality for the attorney 70 to prepare a written response to the RFE. To enable the attorney 70 to quickly and efficiently respond to common requests, the response builder 800 provides functionality for the attorney 70 to store and select subject matter paragraphs 236 and insert petition data 500 and/or petitioner data 400 into the RFE response. Finally, the RFE response builder generates an RFE response, for example as shown in FIG. 8M.

Accordingly, as described above, the RFE response builder 800 enables the attorney 70 to notify the petitioner 50 and/or the beneficiary 40 that an RFE has been received, identify a timeline 720 of subtasks 714 (to be performed by the attorney 70, the petitioner 50, and/or the beneficiary 40) to respond to the RFE, gather the requested information and/or documents from the petitioner 50 and/or the beneficiary 40, and prepare an response to the RFE.

Like the neural network-enabled petition analysis module 600 described above, the RFE response builder 800 may also store reference data that includes past petitions 390 that have both received RFEs and have avoided RFEs. Accordingly, by analyzing the petition data 500 and the beneficiary data 400 of those past petitions 390, the system 200 can develop a model that identifies the petition data 500 and the beneficiary data 400 indicative of a petition that is likely to receive an RFE, which can be used to provide insight into why an RFE was issued. Additionally, for the past petitions 390 that have received RFEs, the reference data may include the disposition of those RFEs and the system 200 can develop a model to identify the information to include in an RFE response that is most likely to obtain a favorable result.

### Journey-Based User Interfaces

As described above, the system 200 includes a beneficiary UI 234 that provides a number of features that are common to all beneficiaries 40. Additionally, the system 200 includes “journey-based” user interfaces (e.g., smartphone applications) that provide additional features for specific beneficiaries 40. Each of the journey-based user interfaces enable the system 200 to define and suggest specific tasks 710 (and subtasks 714) for each type of user and include support for the activities those specific users need in their journey.

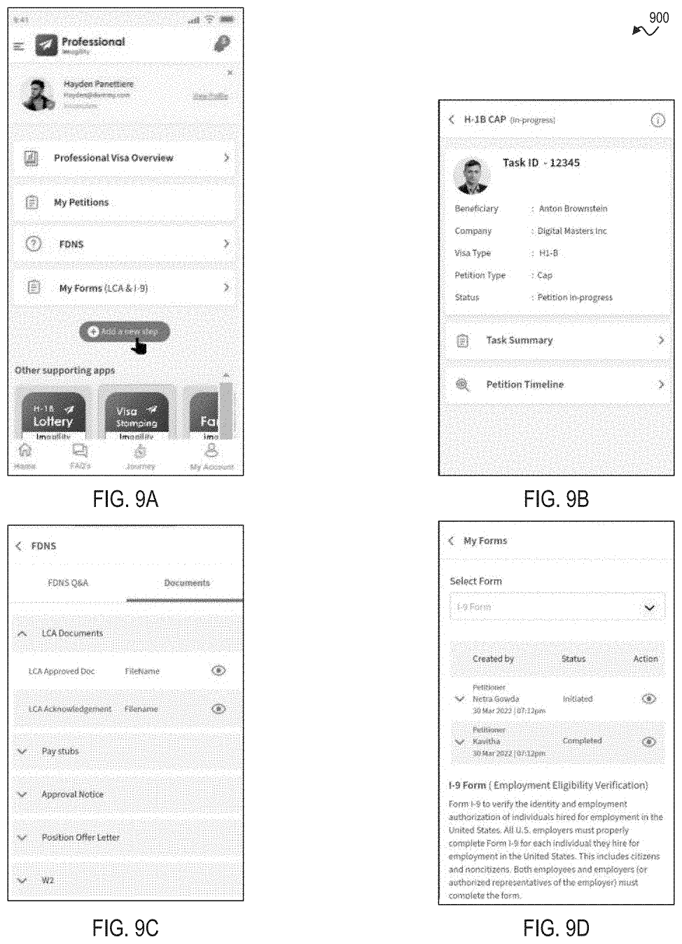

FIGS. 9A through 9D are views of a professional UI 900 for beneficiaries seeking employment-based visas according to an exemplary embodiment.

As shown in FIGS. 9A through 9D, the professional UI 900 enables temporary workers/professionals to enter or update their beneficiary data 400 and track petitions 390 filed by their companies (petitioners 50). The professional UI supplements the web application (described above with reference to FIGS. 4A-4D). Through the professional UI 900, professional beneficiaries 40 seeking employment-based visas can input and/or update their beneficiary data 400, including personal details 410, education information 478, work experience 479, and immigration details 430, upload supporting documents, track the progress of active petitions 390, view Fraud Detection and National Security (FDNS) details, view 1-9 and Labor Condition Application (LCA) status, etc. The professional UI 900 allows professional beneficiaries 40 to be engaged in the process of petition building and have complete transparency and visibility into the progress of the petition 390.

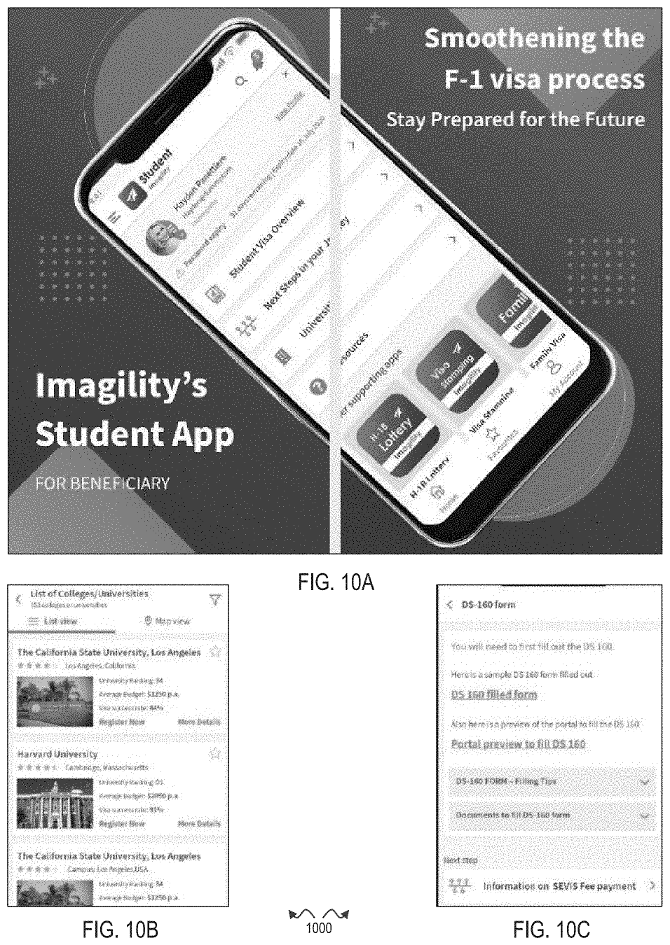

FIGS. 10A through 10D are views of a student UI 1000 for students seeking F-1 visas according to an exemplary embodiment.

To smoothen the F-1 visa process for students, the student UI 1000 student beneficiaries 40 find universities of their choice, apply to them, and prepare for the visa process. All this is done by consolidating information about universities, the visa process and interview tips in the student UI 1000. Student beneficiaries 40 can search for suitable universities based on field of study, degree level and location, enabling student beneficiaries 40 to shortlist universities efficiently.

Through the student UI 1000, student beneficiaries view information on Student and Exchange Visitor Program (SEVIS) fee payment and set their path post course completion. Once student beneficiaries 40 provide their profile information via the student UI 1000, that beneficiary data 400 is stored by the system 200, which includes the features for guiding the beneficiary 40 through the visa and immigration process described above.

In some embodiments, the system 200 also includes an H-1B lottery UI that helps beneficiaries 40 connect with petitioners 50 that may sponsor them. To simplify the H-1B lottery process for beneficiaries 40, the H-1B lottery UI helps beneficiaries 40 and petitioners 50 connect and make informed decisions, enabling those beneficiaries 40 and petitioners 50 to build an H-1B petition 390 collaboratively if the beneficiary 40 is selected in the lottery. The H-1B lottery UI provides comprehensive information about the lottery process and beyond, helping beneficiaries 40 understand the eligibility criteria before registering for an H-1B visa, search for petitioners 50 who might sponsor the beneficiary 40, view profiles of these companies, shortlist companies based on their immigration track record, and register with prospective employers. Accordingly, the H-1B lottery UI gives employers and candidates a chance to evaluate each other using the data present in the H-1B lottery UI and connect mutually.

In some embodiments, the system 200 also includes a petitioner lottery UI to help petitioners 50 connect with beneficiaries 40. To simplify the lottery process for petitioners 50, the petitioner lottery UI helps petitioners 50 connect with beneficiaries 40 and make informed decisions. The petitioner lottery UI allows petitioners 50 to streamline the process of registering the beneficiary 40 and do basic screening to check their eligibility for the H-1B, in order to process the right candidate for the H-1B petition. Through the petitioner lottery UI, petitioners 50 can create a company profile to attract the right talent, view beneficiary registrations, pick the best qualified beneficiaries 40, and co-brand with an attorney 70. Employers and candidates get a chance to evaluate each other using the data present in the petitioner lottery UI and connect mutually.

In some embodiments, the system includes an attorney lottery UI. After the lottery process, petitioners 50 usually expect attorneys 70 to get in touch with beneficiaries 40 and collect beneficiary data 40 to generate the petition 390. Instead, using the attorney lottery UI, attorneys 70 can encourage petitioners 50 to collect beneficiary data 400 from beneficiaries 40 in a streamlined manner, right from the beginning, which also benefits petitioners 50 in selecting the right beneficiaries 40. The attorney lottery UI simplifies the simplifies attorney's task in this long edit process, which would otherwise be spreadsheets, email exchanges etc. Consequently, this brings down a substantial workload of attorneys 70. The attorney lottery UI helps attorneys 70 start building a technology-based practice to cover end to end immigration. Meanwhile, with the system 200 described above, attorneys 70 efficiently manage all immigration processes of their clients and beneficiaries 40. The attorney lottery UI can be co-branded with the attorney's clients (petitioners 50) to streamline the process of registering the beneficiary 40 (and do basic screening to check their eligibility for the H-1B) to process the right candidate for the H-1B petition.

FIGS. 11A through 11C are views of a visa stamping UI 1100 according to an exemplary embodiment.

As shown in FIGS. 11A-11C, the visa stamping UI 1100 enables beneficiaries 40 to set overseas trip details, prepare for their interview, and receive tips for successfully interviewing. The visa stamping UI 1100 also provides functionality for users to share visa stamping data 210, including interview questions and the outcomes of interviews. Accordingly, in some instances, beneficiaries 40 may learn which interview questions may be asked by a consular official (and whether a previous answer was acceptable to that consular official) before the interview even takes place. In some embodiments, the system 200 may aggregate the visa stamping data 210 and provide information to future beneficiaries 40 to increase the likelihood of successfully obtaining a visa. For example, the system 200 may identify the consulate and/or consular official most likely to provide a positive outcome, the time of day and day of the week in which beneficiaries 40 are most likely to receive a positive outcome, etc.

Additionally, the system 200 may include “journey-based” user interfaces for investors, families, refugees seeking asylum, etc.

While preferred embodiments have been described above, those skilled in the art who have reviewed the present disclosure will readily appreciate that other embodiments can be realized within the scope of the invention. Accordingly, the present invention should be construed as limited only by any appended claims.

What is claimed is:

1. A machine learning-enabled system for generating and analyzing visa and immigration petitions, the system comprising:
a user interface for receiving petition data, beneficiary data, and subject matter paragraphs;
a petition building module that generates visa and immigration petitions by inserting the beneficiary data and the petition data into visa and immigration forms and combining the subject matter paragraphs and the beneficiary data and the petition data to generate support letters;
a reference database that stores reference data including past beneficiary data and past petition data of past petitions that have been granted and denied; and
a petition analysis module that includes a neural network, trained on the reference database to develop a model for determining the likelihood of visa and immigration petitions being granted, that analyzes the petition data and the beneficiary data of the generated petition and outputs an indication of the likelihood of the generated petition being granted.

2. The system of claim 1, wherein the neural network estimates the likelihood that the generated petition will be granted by determining a score S for each determination I in each of n categories C and calculating a final score
$$Z = {\sum }_{i = 1}^{n} ( S [ I [ C [ i ] ] ] ) .$$

3. The system of claim 2, wherein the neural network is trained on the reference data to identify the determinations I and scores S such that such that the final score Z is indicative the likelihood that the past petitions were granted or denied.

4. The system of claim 3, wherein:
the user interface provides functionality to select one of a plurality of visa types and immigration categories;
the petition building module selects a visa or immigration form based on the selected visa type or immigration category and generates the petition by populating the selected form; and
the neural network is trained to identify determinations I and scores S for each of the plurality of visa types and immigration categories.

5. The system of claim 1, further comprising:
a standard occupational classification (SOC) database that includes occupational duties and SOC codes for specialty occupations.

6. The system of claim 5, wherein the graphical user interface provides functionality to:
select an SOC code for an employment-based petition;
view the occupational duties for the specialty occupation corresponding to the selected SOC code; and
input required duties for a position to be filled by a beneficiary of the employment-based petition.

7. The system of claim 6, wherein:
the graphical user interface provides functionality to match each of the required duties for the position to one of the occupational duties for the specialty occupation; and
the petition building module generates a support letter that includes a draft argument that the position qualifies as a specialty occupation because the required duties match the occupational duties of the specialty occupation that corresponds to the selected SOC code.

8. The system of claim 5, wherein:
the reference data includes generic job descriptions and specific job descriptions; and
the petition analysis module includes a neural network classifier, trained on the generic job descriptions and the specific job descriptions, that analyzes the required duties input via the graphical user interface and generates a classifier score indicative of the specificity of the required duties; and
the indication of the likelihood of the generated petition being granted is based at least in part of the classifier score.

9. The system of claim 8, wherein:
the SOC database further includes occupational skills for the specialty occupation corresponding to the selected SOC code; and
the petition analysis module further includes a keyword analyzer that performs a keyword search of the petition data for terms included in the SOC database and generates a keyword score indicative of the number of skills required to fill the position; and
the indication of the likelihood of the generated petition being granted is further based at least in part of the keyword score.

10. The system of claim 9, wherein:
the occupational skills for the specialty occupation corresponding to the selected SOC code include technical skills, domain skills, and process skills; and
the keyword analyzer that performs a keyword search of the petition data for terms included in the SOC database and generates a tools score indicative of the number of technical skills required to fill the position, a domain score indicative of the number of domain skills required to fill the position, and a process score indicative of the number of process skills required to fill the position.

11. A machine learning-implemented method generating and analyzing visa and immigration petitions, the method comprising:
providing a user interface for receiving petition data, beneficiary data, and subject matter paragraphs;
generating visa and immigration petitions by:
inserting the beneficiary data and the petition data into visa and immigration forms; and
combining the subject matter paragraphs and the beneficiary data and the petition data to generate support letters;
storing reference data that includes past beneficiary data and past petition data of past petitions that have been granted and denied;
training a neural network, using the reference data, to develop a model for determining the likelihood of visa and immigration petitions being granted; and
analyzing the petition data and the beneficiary data of the generated petition, by the neural network, and determining indication of the likelihood of the generated petition being granted.

12. The method of claim 11, wherein the indication of the likelihood that the generated petition will be granted is determined by determining a score S for each determination I in each of n categories C and calculating a final score
$$Z = {\sum }_{i = 1}^{n} ( S [ I [ C [ i ] ] ] ) .$$

13. The method of claim 12, wherein the neural network is trained on the reference data to identify the determinations I and scores S such that such that the final score Z is indicative the likelihood that the past petitions were granted or denied.

14. The method of claim 13, wherein:
the user interface provides functionality to select one of a plurality of visa types and immigration categories;
the generated petition is generated by selecting a visa or immigration form based on the selected visa type or immigration category and populating the selected form; and
the neural network is trained to identify determinations I and scores S for each of the plurality of visa types and immigration categories.

15. The method of claim 11, further comprising:
storing a standard occupational classification (SOC) data that includes occupational duties and SOC codes for specialty occupations.

16. The method of claim 15, wherein the graphical user interface provides functionality to:
select an SOC code for an employment-based petition;
view the occupational duties for the specialty occupation corresponding to the selected SOC code; and
input required duties for a position to be filled by a beneficiary of the employment-based petition.

17. The method of claim 16, wherein:
the graphical user interface provides functionality to match each of the required duties for the position to one of the occupational duties for the specialty occupation; and
generating the generated petition comprises generating a support letter that includes a draft argument that the position qualifies as a specialty occupation because the required duties match the occupational duties of the specialty occupation that corresponds to the selected SOC code.

18. The method of claim 15, wherein the reference data includes generic job descriptions and specific job descriptions, the method further comprising:
training a neural network classifier on the generic job descriptions and the specific job descriptions;
analyzing the required duties input via the graphical user interface, by the neural network classifier, and generating a classifier score indicative of the specificity of the required duties.

19. The method of claim 18, wherein the SOC data further includes occupational skills for the specialty occupation corresponding to the selected SOC code, the method further comprising:
performing a keyword search of the petition data for terms included in the SOC data and generating a keyword score indicative of the number of skills required to fill the position.

20. The method of claim 19, wherein the occupational skills for the specialty occupation corresponding to the selected SOC code include technical skills, domain skills, and process skills, the method further comprising:
performing a keyword search of the petition data for terms included in the SOC data and generating a tools score indicative of the number of technical skills required to fill the position, a domain score indicative of the number of domain skills required to fill the position, and a process score indicative of the number of process skills required to fill the position.
